(19) United States
(12) Patent Application Publication
(10) Pub. No.: US 2012/0135125 A1
(43) Pub. Date: May 31, 2012

(54) CONCENTRATED, CREAMY TO SOLID AND DRY COMPOSITIONS OF AN OIL-IN-WATER EMULSION, METHOD FOR THE PRODUCTION THEREOF AND USE THEREOF FOR PRODUCING IMPROVED FOODS IN TERMS OF SENSORY ASPECTS AND NUTRITION PHYSIOLOGY

(76) Inventors: Gerald Muschiolik, Potsdam (DE); Klaus O. Paulus, Wadenswil (CH)

(21) Appl. No.: 13/266,912

(22) PCT Filed: Apr. 30, 2010
(86) PCT No.: PCT/EP10/02654

§ 371 Date: Jan. 23, 2012

(30) Foreign Application Priority Data
Apr. 30, 2009 (DE) 10 2009 019 550.5
Apr. 30, 2009 (DE) 10 2009 019 551.3

(51) Int. Cl. A23D 7/005; A23L 1/0534; A23L 1/30; A23L 1/0524

(52) U.S. Cl. 426/602

(57) ABSTRACT

The invention relates to an oil-in-water emulsion, substantially comprising protein, polysaccharide and oil or fat having unique stabilizing properties, which is suited for use as a thickener, suspending agent, coating material and as an additive to food in the production of a plurality of products. Furthermore, foods are provided which have improved properties in terms of sensory aspects and nutrition physiology compared to conventionally produced products, and a method for the production thereof is provided. In addition, the emulsion and products produced according to the invention can be dried and subsequently rehydrated in order to obtain compositions that have substantially the same properties as the non-dried compositions.

### FIELD OF THE INVENTION

In general, the present invention relates to biopolymer-based compositions having a continuous aqueous phase and a distributed fat or oil phase as well as to a simple and continuous method for the production thereof. The distributed oil phase is stable and does not even separate after long standing periods. The stability of said compositions in terms of the separation of aqueous and oil phases is based on the unique method employed for their production and does not require any additional emulsifying or dispersing agents. Said compositions have unique characteristics which render them suitable for a use as thickeners, suspending agents, coating materials and fat substitutes in food products. Furthermore, products produced according to the present invention can be dried and subsequently rehydrated to yield compositions that have essentially the same characteristics as the non-dried compositions.

### BACKGROUND OF THE INVENTION

Foods and other products such as cosmetics that are creamy and/or rich in texture and full-bodied are typically dependent on the addition of hydrocolloids and/or finely dispersed particles (e.g. in the form of microparticles or emulsified fat) in order to yield the desired consistency. In general, the emulsified fat is provided in the form of liquid or spray-dried creamifying non-milk agents, whole milk or skimmed (low-fat) milk. The amount of fat that is commonly found in these products provides insufficient advantages regarding consistency and/or water binding capacity, which often results in separation upon prolonged periods of storage.

One alternative approach is the use of components that increase the consistency (viscosity) of the product. Hydrocolloid gums and water-soluble starches are commonly used to provide consistency in beverages, i.e. to increase their viscosity. Hydrocolloid gums, however, are often associated with negative consistency characteristics, rendering the product “slimy” or “sticky”.

Water-soluble starches can also be used to increase the viscosity. However, the amount of water-soluble starch that is required to provide these characteristics is usually larger as compared to the use of gums, so that a larger amount of solid substance needs to be added. In the case of instant products, this results in an additional large proportion of solid substance. Although it is possible to increase richness and creaminess with a higher dosage of solid substances, this, however, signifies an increased volume of the final product and is therefore associated with difficulties in the formulation of products that aim at obtaining a final product of high quality at a low input of raw materials.

### PRIOR ART OF THE PRESENT INVENTION

The prior art is, for instance, represented by the international patent application WO 03/003850, wherein compositions that essentially consist of pectin, alginate and cellulose are proposed for stabilizing and increasing the viscosity of cosmetic products, healthcare products, foods and beverages. Document EP 340 035 A2 describes aqueous dispersions of insoluble, micro-fragmented, ionic polysaccharide/protein complexes for use as nutrients, the viscosity- or consistency-controlling means, both in conventional and novel food products. However, there is no method described in the prior art for producing a water-in-oil emulsion that produces a creamy mouthfeel as well as creaming stability to a wide product variety of edible formulations ranging from food products to pharmaceutical products and reduces or eliminates, for instance, the separation of water in other products, including industrial products.

### SUMMARY OF THE INVENTION

The present invention relates to a method for producing an oil-in-water (O/W) emulsion (herein also referred to as “PPS”, i.e. protein/polysaccharide stabilizer) that essentially consists of protein, polysaccharide, oil, or fat and optionally water. In particular, the present invention relates to a method for producing an oil-in-water (O/W) emulsion containing, as related to the total weight of the emulsion, 0.2 to 10.0% by weight of protein; 0.3 to 10.0% by weight of polar polysaccharide; 0.1 to 60% by weight of a fat/oil component; and optionally 0 to 30.0% by weight of a polyol. If required, 0 to 1.0% by weight of a flavoring agent; 0 to 1.0% by weight of a coloring agent; 0 to 0.2% by weight of preservatives; and/or 0 to 1.0% by weight of an acid may additionally be present, as well as active ingredients that are introduced or formulated into a desired final product via PPS, for example enzymes into washing powders; vitamins, essential fatty acids, pigments and metals such as titanium oxide into food products or healthcare products such as sunscreen lotions; therapeutically active ingredients such as Taxol into pharmaceutical products; fungicides into plant protection agents; aluminum hydroxide into drill cooling water and the like.

The present invention is based on the surprising finding that a stable and non-separable emulsion which is composed of microscopic oil drops that are dispersed throughout an aqueous phase of a biopolymer or biopolymer mixture can be produced in the absence of conventionally used emulsifying or dispersing agents by means of dispersing and finely emulsifying a phase that essentially consists of a fat/oil component (oil phase) into an aqueous phase that contains protein and polysaccharide, wherein for producing the aqueous phase the protein and polysaccharide are separately dissolved under stirring before they are mixed together. For producing the emulsion according to the present invention it is alternatively also possible to mix the oil phase with at least a portion of the polysaccharide under stirring and to subsequently disperse and finely emulsify it into an aqueous phase that contains the protein and optionally still a portion of the polysaccharide. The particle size of the dispersed oil or fat drops of PPS is preferably x_{50.3}≦10 μm (volume-related median value) in maximum dispersion. Preferably, the dry mass of PPS is between 5 and 60% by weight, wherein the reduction of the dry mass of PPS is essentially achieved by reducing the oil or fat content.

The resulting emulsions are characterized by the following properties: (1) they are stable and do not exhibit phase separation into their respective oil and water components upon prolonged periods of storage; (2) they are characterized by a comparatively high water binding capacity; (3) according to type, they readily form viscous liquids to creamy pastes that can easily be converted into pourable liquids in the absence of dispersed fat and upon heat input; (4) their cold stability (freezing and thawing) is ensured; (5) their heat stability under sterilization conditions is ensured; (6) they can be dried, for example using a drum drier, to yield solid compositions that are hardly oily to the touch; and (7) dried compositions hydrate easily and are readily re-dissolved in water to yield emulsions that are smooth, stable and free of lumps and have identical or similar characteristics as aqueous compositions that have never been dried before. The smoothness and suppleness of the emulsions according to the present invention render them suitable for use as thickening agents, suspending agents and fat substitutes in food products. The presence of the oil component in the emulsion furthermore makes the emulsion act as emulsifying and dispersing agents and renders them receptive to the addition of a variety of hydrophobic materials, for example other fats, volatile and essential (ethereal) as well as flavoring oils and food flavoring agents, antioxidants, pharmaceutical agents, agricultural chemicals and the like. The compositions are also useful as seed coatings as the oil component provides for a considerable degree of compatibility of the dried composition and the waxy coating that is found on many types of seeds.

According to these findings it is an aim of the present invention to provide a novel class of biopolymer-based emulsions that exhibit an even and stable distribution of oil in all contents up to at least 60% by weight of the emulsion. In a dried state, these compositions are essentially not oily to the touch, in particular those compositions that provide a particle size within the range of 1 μm in the emulsion and/or are loaded with less than about 30% by weight of oil, as related to the combined weight of the aqueous emulsion. In aqueous distribution, the compositions according to the present invention have a non-fatty structure that is still lubricious.

The present invention further relates to compositions and formulations, in particular to dried compositions containing, besides further components, 0.001 to 99.9% by weight of the emulsion according to the present invention. In products containing the emulsion according to the present invention, the emulsion will act to stabilize the distributions of solids and liquids contained in the respective product. Basically, any emulsion according to the present invention can be used in the production of any product that utilizes oil-in-water emulsions, in particular lotions, gels, creams, pastes, lubricants and the like.

According to a further aspect, the present invention relates to a method for producing a food that is altered with respect to its sensory, functional and/or nutritional physiological characteristics, the method comprising the use of PPS. In particular, the present invention relates to a method for the production of a food that is altered with respect to its sensory, functional and/or nutritional physiological characteristics, the method comprising providing an oil-in-water (O/W) emulsion containing the following components, as related to the total weight of the emulsion, 0.2 to 10.0% by weight of protein; 0.3 to 10.0% by weight of polar polysaccharide; 0.1 to 60% by weight of a fat/oil component; 0 to 30.0% by weight of a flavoring oil component; and optionally 0 to 30.0% by weight of a polyol. If required, 0 to 1.0% by weight of a flavoring agent; 0 to 1.0% by weight of a coloring agent; 0 to 0.2% by weight of preservatives; and/or 0 to 1.0% by weight of an acid may additionally be present.

According to the method of the present invention, PPS is employed in food products that are desired to produce a rich and creamy mouthfeel, and it is particularly preferred in those food compositions in which creamifying products have been conventionally used, for example in instant beverages and ready-to-serve beverages such as flavored and non-flavored coffee and tea beverages, hot chocolate, juice-containing beverages, nutritional beverages in the form of shakes, malt beverages and the like; cocktails and mixed beverages, puddings; sauces; gravies; scalded and cooked sausages; burgers and other meals prepared with minced meat; dough and baked goods, dressings; mousse desserts; ice cream; yoghurt; cream cheese; cheese dips and/or spreads; sour cream; vegetable dips and/or spreads; icings, whipped toppings; frozen confectionery; milk; coffee creamer; coffee whitener; and other dips and spreads.

Preferred liquid or flowable food products are dairy- or vegetable-based beverages, desserts, yoghurts and soups. Meal replacements as well as dairy- and vegetable-based beverages and soups are particularly preferred. These food products may also be available in the form of a powder or concentrate which is mixed with a liquid, e.g. with water, in order to produce a food product.

As a result of experiments conducted in accordance with the present invention regarding the production of milk products it was also surprisingly found that PPS is suitable for producing food replacements. This applies, in particular, to dietetic food replacements having a dry mass that essentially consists of PPS, as a preferred embodiment utilizes PPS for the production of which polysaccharides are used that have an energy content of essentially 0% and a fiber content of 70% to 80%. Thus, the present invention also particularly relates to methods for producing low-calorie food products that are calorie-reduced as compared to conventional products, in particular dietetic food products and beverages.

It is a further advantage of the present invention that the method according to the present invention allows the production of food products that do not contain any GMO (genetically modified organism) materials (the use of vegetable proteins that are free of GMO is possible) and basically consist of natural raw materials. Furthermore, the production using basic raw materials in organic quality (proteins, polysaccharides) is provided. The same applies to oils that are introduced according to the method of the present invention. With respect to organic products and infant formulas, this is an essential advantage of the method according to the present invention. Thus, the present invention also relates to food products that are produced according to the method of the present invention and meet the requirements made on certified organic products.

Said method firstly requires the provision of PPS, the dry mass content of which preferably is between 5 and 60% by weight, particularly preferably between 20 and 25% by weight. The method according to the present invention further comprises mixing PPS with a suitable basic food material for producing the desired food product, wherein the emulsion is present in a ratio of 0.1 to 75% by weight, as related to the basic food material. Further objectives and advantages of the present invention will be apparent from the following explanation. Regarding the aspect of producing foods that are improved with respect to their sensory and nutritional physiological characteristics, it is further referred to the German patent application DE 10 2009 019 551.3, filed on Apr. 30, 2009, the priority of which is claimed by the present application and the disclosure content of which is hereby incorporated by reference in the present description.

### DETAILED DESCRIPTION OF THE INVENTION

### Definitions

The terms “ready-to-serve” food or beverage; “ready-to-eat” food; and “ready-to-drink” beverage are used interchangeably herein in order to define food and beverage products that are available in a form to be immediately used or consumed. Foods according to the present invention basically comprise any consumable, edible and drinkable composition and preferably include the classes of goods specified with exemplified representatives as indicated in the tables of FIGS. 4 to 7. Basically, the term food also comprises animal feed products and feed additives, such as dog or cat food, as the veterinary sector meanwhile also increasingly focuses on a diet that is balanced and acceptable for the animals. Furthermore, the foods according to the present invention can also be used, in particular in the form of concentrated feed products, for animals in the sector of high performance sports, for example in equestrian sports and dog racing.

The terms “instant” and “soluble” are used interchangeably herein in order to define products and compositions such as instant coffee products, soluble detergent powders and tablets which exhibit a relatively good solubility in water, in particular in hot water. A mixture (either in the form of a powder, a dried mixture, a concentrate or an emulsion) is sold by the manufacturer and is typically mixed with an aqueous liquid or a diluent (i.e. water, milk or any other aqueous medium) by the consumer in order to provide a ready-to-use product or a ready-to-serve food or beverage.

In the production of sausage products, the term “proportion of water to be added” refers to the proportional amount of water that is added to the meat mass, for example in the form of chipped ice during the bowl cutting process in the production of sausage meat for scalded sausage products. A part of said “proportion of water to be added” may be replaced by PPS (in meat for scalded sausages PPS is preferably added in a chopped and frozen state during the bowl cutting process, in meat for cooked sausages mixed in a non-frozen state subsequently to the cooking process).

In principle, a “basic food material” can be any edible food composition for human consumption immediately before or after preparation and is rendered palatable by dissolution, dilution, cooking, frying, baking and the like. The basic food basis can be any basis of the dairy or non-dairy type. Examples of basic food materials for the introduction of PPS variants are the foods indicated in the tables of FIGS. 4 to 7.

Unless otherwise indicated, all amounts, parts, proportions and percentages as used herein refer to the weight.

### SOURCES OF COMPONENTS OF THE EMULSION FOR THE METHOD ACCORDING TO THE PRESENT INVENTION

Unless otherwise indicated, the terms “fat” and “oil” or “fat component” and “oil component” are used interchangeably herein.

Lipid (or fat) is a general term referring to substances that are present in living cells and are merely composed of a nonpolar hydrocarbon portion or a hydrocarbon portion with polar functional groups (see Encyclopedia of Chemistry, 3^{rd} edition, editors C. A. Hampel and G. G. Hawley, 1973, page 632). Most of the fats are insoluble in water and can be dissolved in fat solvents such as ether or chloroform. Fats represent a main class of the lipid family. Fats are glycerol esters of fatty acids and are in most cases palmitic, stearic, oleic and linoleic acids, although many other naturally occurring fatty acids can also be found. Most of the fats are present in the form of glycerol triesters. In Hackh's Chemical Dictionary, 4^{th} edition, editor G. Grant, 1969, on page 470, oil is defined as a liquid that cannot be mixed with water, is generally flammable and can be dissolved in ether. Oils are divided into three categories: (1) fatty substances from plant and animal organisms; (2) volatile or essential (ethereal) oils, i.e. the aromatic principles of plant organisms; and (3) mineral oils, fuel oils and lubricants, i.e. hydrocarbons that are derived from petroleum and products thereof.

Although any fat can be used for producing the compositions according to the present invention, the flowable and edible vegetable oils, such as for example soy bean oil, corn oil, cotton seed oil, sunflower oil, palm oil, coconut oil, rapeseed oil, MCT oils and olive oil and the semi-solid hydrated vegetable oils, the fats of animal origin, such as fish oil, butter, bacon or tallow, and the refined and non-toxic mineral oils that are usually referred to as paraffin oils, are preferred. Also comprised are oils and fats that may be partially or totally hydrated or otherwise modified as well as non-toxic modified fats having characteristics similar to those of the triglycerides and are herein referred to as partially or totally indigestible fat. The term may also comprise calorie-reduced fats and edible indigestible fats, oils or fat substitutes. The terms “fat” or “oil” also refer to 100% non-toxic fat materials having characteristics similar to those of triglycerides. In general, the terms “fat” or “oil” also comprise fat-containing compositions, like cream and fat substitutes, which materials can be partially or totally indigestible.

In the following disclosure, the present invention will be described mainly with reference to the addition of oil as an incorporated fat. It is to be noted that the term “oil” is often used interchangeably with the terms “lipid” and “fat” herein and may be replaced by other lipids (i.e. fats and hydrocarbons). Although it is obvious to the person skilled in the art that emulsifying fats may also be comprised by the scope of the terms “lipid” and “fat” herein, the method according to the present invention does not require the inherent emulsifying characteristics of said materials in order to yield the highly distributed biopolymer/oil products according to the present invention.

In particular embodiments, for example for the production of food additives, the “fat component” and “oil component” is enriched with essential and/or “functional” fatty acids or fatty acid esters, such as long-chain polyunsaturated fatty acids (LC-PUFA), in particular linolenic and linoleic acid, eicosapentaenoic acid (EPA), docosahexaenoic acid (DHA), arachidonic acid (AA) or glycerides and phosphoglycerides thereof. According to the present invention, any combination of the above-mentioned fat and oil components may be employed.

The term “flavoring oil component” comprises oils like herb or spice oil concentrate, peel oil, fruit oil and other oils and fats as defined in the above that are capable of conferring specific nuances of flavor to a food. The production of enriched vegetable oils (edible oils), preferably from processed and peeled oil seeds with parts of herb and/or spice plants and/or fruits is, in principle, known from document DE 101 01 638 C2. Examples of flavoring oils comprise, inter alia, oil derived from processed and peeled oil seeds with parts of herb plants such as thyme, basil, coriander and oregano; herb plants such as fennel, for example fennel oil concentrate; or fruits such as sea buckthorn, for example pulp oil and seed oil derived from sea buckthorn or oils derived from citrus fruits.

Polysaccharides (PS) represent an important group of biopolymers. For the purposes of the present invention, the polysaccharides preferably are hydrocolloids, i.e. high-molecular, polar, water-soluble biopolymers (Dickinson, The role of hydrocolloids in stabilizing particulate dispersions and emulsions; In: Phillips Glyn O, Williams P A, Wedlock D J (Eds): Gums and stabilizers for the food industry 4, Wrexham 1988; 249-264). Preferably, the polysaccharides employed are polysaccharides containing carboxyl groups. In this context, the presence of calcium ions (Ca) is preferably to be avoided with the use of alginate and low-esterified pectin, however. Polysaccharides that are contemplated within the scope of the present invention comprise, but are not limited to xanthane, carboxymethylpullulan, carrageenan, chitosan, gellan, sodium carboxymethylcellulose, sodium alginate and pectin.

Pectins (PE) are polysaccharides that are present in the cell walls of higher plants. They are isolated from the middle lamella or the primary cell wall. When present in the middle lamella, pectin acts as a sealant while it is actively involved in regulating the water balance of the cell when present in the primary cell wall. Pectin is obtained from the peels of citrus fruits and from apple or beet pomace. Pectins are heterogeneous complex polysaccharides and consist of partially esterified α-1,4-linked D-galacturonic acid units (Kunz, Lexikon der Lebensmitteltechnologie. Springer Verlag, Heidelberg, 1^{st} edition, 1993). This main framework is interrupted by rhamnoses having side chains that consist of neutral sugars (arabinose, galactose). The hydroxyl groups at the C1 and C3 atoms, respectively, of the galacturonic acid units are partially acetylated or substituted by further neutral sugars (such as D-galactose, D-xylose, L-arabinose, L-rhamnose) (Ebert, Biopolymere: Struktur und Eigenschaften. BG Teubner Verlag, Stuttgart, 1993; Kunz, (1993), see supra). The carboxyl groups of polygalacturonic acid are partially esterified with methanol or amidated. The molecular mass of the commercially available pectins is between 30,000 and 200,000 g/mol (Schweiz. Lebensmittelbuch Gelier-und Verdickungsmittel, 1993). In general, pectins can be distinguished by their degree of esterification (DE). The degree of esterification indicates the percentage of carboxyl groups that are esterified with methanol. Pectin having a DE of >50 is referred to as high-esterified pectin, whereas pectin having a DE of <50 is referred to as low-esterified. Amidated pectin is low-esterified pectin which additionally contains amide groups. The degree of amidation (DA) is defined as the percentage of amidated carboxyl groups (Rolin, Pectin. In: Whistler R L, BeMiller J N (Eds): Industrial gums polysaccharides and their derivatives. Marcel Dekker Inc., New York, 3^{rd} Edition (1993), 257-293). Pectins are commercially available from a number of suppliers. It is understood that, according to the present invention, the term “pectins” also comprises polysaccharides that are not pectins in the strict sense of their definition, but have identical or similar characteristics as pectins owing to the derivatization of, e.g., polygalacturonic acid or multiple sugars by hydroxylation, carboxylation, esterification and/or amidation and can therefore be employed equivalently. Within the EU, pectin is approved as a food additive for a variety of products under the designation E440.

Sodium carboxymethylcellulose (CMC) is a cellulose-based biopolymer and is produced by etherifying cellulose in a sodium hydroxide solution with sodium monochloroacetate (Feddersen et al., Sodium carboxymethylcellulose. In: Whistler R L, BeMiller J N (Eds): Industrial gums polysaccharides and their derivatives. Marcel Dekker Inc., New York, 3rd Edition (1993), 537-578). The degree of substitution (DS) is given as a measure for the degree of etherification. The degree of substitution indicates the average number of etherified hydroxyl groups within a glucose unit. The presence of the three reactive hydroxyl groups allows for the introduction of three sodium carboxymethyl groups. The characteristics of sodium carboxymethylcellulose depend on its degree of substitution and its degree of polymerization (Belitz et al., Lehrbuch der Lebensmittelchemie. Springer-Verlag, Berlin, 4th Edition, 1992). The degree of polymerization indicates the average number of monomeric molecules that are joined to form a macromolecule during the polymerization process. Sodium carboxymethylcellulose, which is preferred according to the present invention, has an average molecular mass of 125,000 g/mol. The average degree of polymerization is 582 β-D glucose units. Within the EU, sodium carboxymethylcellulose is approved as a food additive in the group of thickening and gelling agents under the designation E466.

It is understood that the term “sodium carboxymethylcellulose” according to the present invention also comprises polysaccharides that are not sodium carboxymethylcellulose in the strict sense of its definition, but have identical and/or similar characteristics as sodium carboxymethylcellulose due to, e.g., the derivatization of, e.g., cellulose or other multiple sugars by hydroxylation, carboxylation, esterification and/or etherification and can therefore be employed equivalently.

The term “protein” comprises each and any peptide or polypeptide that essentially consists of amino acids. Among the protein sources that are suitable for the production of PPS are vegetable proteins (in particular oil seed proteins derived from cotton, palm tree, rapeseed, safflower, cocoa, sunflower, sesame, soy, pea, potato, peanut and the like), animal proteins such as sodium caseinate, bovine serum albumin, oral albumin and microbial proteins such as yeast proteins and so-called “single-cell” proteins.

Preferred proteins comprise whey protein isolate, milk protein concentrate, sodium caseinate or skimmed milk powder and non-milk whey proteins such as vegetable proteins, in particular proteins derived from soy, pea and lupine; see also the Examples. Whey is generated as a byproduct in cheese production. It accounts for about 80 to 90% of the total milk volume and contains many nutrients. Whey proteins are important components of whey. Whey proteins are those proteins that remain in the whey after the separation of caseins from milk by means of acid or rennet precipitation (Barth and Behnke, Ernährungsphysiologische Bedeutung von Molke and Molkenbestandteilen. Nahrung 41 (1997), 2-12). In this context it is understood that the term “proteins” also comprises hydrolyzed proteins such as hydrolyzed whey proteins. The term “protein” further comprises biologically active proteins such as enzymes which are, for example, used in the production of yoghurt and cheese or in washing powder; hormones such as insulin for pharmaceutical products; antigens for vaccines; proteases in reagents and the like.

The term “polyol” refers to a multivalent alcohol having at least 4, preferably from 4 to 11 hydroxyl groups. Polyols comprise sugars (i.e. monosaccharides, disaccharides and trisaccharides), sugar alcohols, other sugar derivatives (i.e. alkyl glucosides), polyglycerols such as diglycerol and triglycerol, pentaerythritol, sugar ethers such as sorbitan and polyvinyl alcohols. Specific examples of suitable sugars, sugar alcohols and sugar derivatives comprise xylose, arabinose, ribose, xylit, erythrite, glucose, methyl glucoside, mannose, galactose, fructose, sorbitol, maltose, lactose, sucrose, raffinose and maltotriose.

“Flavoring agents” are flavoring substances that are preferably added to the food compositions in amounts that will confer a mild and pleasant flavor. The flavoring agent can be any typically employed and commercially available flavor. In case a non-spicy flavor is desired, the flavoring agents will typically be selected from different types of cocoa, pure vanilla or from artificial flavors such as vanillin, ethyl vanillin, chocolate, malt, mint, yoghurt powder, extracts, spices like cinnamon, nutmeg and ginger, mixtures thereof and the like. It will be appreciated that a plurality of flavor variations can be obtained by combining the basic flavors. In case a rather spicy flavor is desired, the flavoring agents will typically be selected from different types of herbs and spices. Suitable flavors may also include condiments such as salt and fake fruit or chocolate flavors, either alone or in any suitable combination thereof. Flavors that will additionally mask the off-flavors of vitamins and/or minerals and other ingredients are preferably added to the respective food compositions. Other flavors like fruit flavors may also be used, further examples of which are the flavors of pineapple, almond nut, amaretto, anisette, brandy, cappuccino, Creme de Menthe, Grand Marnier©, pistachios, sambuca, apple, camomile, french vanilla, Irish Cream, Kahlua, lemon, peppermint, macadamia nut, orange, orange leaf, peach, strawberry, grapes, raspberries, cherries, coffee, chocolate, mocca and the like.

Further components that may be ingredients in the emulsion employed comprise, for example, coloring ingredients, plant extracts, plant juices, vitamin-containing plant concentrates, mineral-containing products and preservatives.

### FIGURES

FIG. 1: Schematic representation of the method according to the present invention for producing the oil-in-water (O/W) emulsion of the present invention (herein also referred to as “PPS”). In embodiment (A), a phase that essentially consists of the fat/oil component (oil phase) is dispersed in an aqueous phase that contains the protein and polysaccharide; also see Example 1. In a further embodiment (B), the oil phase is mixed with a polysaccharide and is subsequently dispersed in an aqueous phase that contains the protein; see also Example 2. In a further embodiment (C), a part of the intended amount of polysaccharide (PS) is introduced into the oil phase according to variant B and the oil+PS phase is dispersed in the P+PS phase according to variant A, wherein preferably the amount of polysaccharide (PS) is correspondingly adapted to the amount of PS that is already contained in the oil phase. In any case, the process temperature should be kept below the denaturation temperature range of the proteins (e.g. not above 60° C. with whey protein) until the emulsion is obtained.

Variant A
A¹: The one or more oil and/or fat components (O) are heated to about 50° C. or until all the fat has melted at 60° C. (oil phase). Ideally, the oil phase has a density of about 1.0 g/cm³.
A²: Polysaccharide (PS) is slowly added to the aqueous phase (about 50 to 90° C., preferably 70° C. with the use of pectin or CMC) using a magnetic stirrer or an RW 16 basic stirring device equipped with a star stirrer (IKA Labortechnik, Staufen, Germany) at about 1,500 rpm and dissolved for about 1 to 2 h until a clear solution is obtained. In the presence of a polyol like sucrose, the polysaccharide is dry-mixed with the polyol and is then dispersed in the aqueous phase. The proportion of water for dissolving the polysaccharides and optionally the polyol preferably amounts to about 75% of the total water volume. Prior to further use, the PS solution may be sterilized for 10 min at 95° C.
A³: Protein (P) is slowly added to the aqueous phase (about 50° C.) using a magnetic stirrer or a star stirrer (modified stirring disc) at 1,000 to 1,500 rpm and dissolved for about 1 h. In case of foam formation, the rotating speed of the stirrer is reduced. The proportion of water for dissolving the proteins preferably amounts to about 25% of the total water volume. In case the protein has an acidic pH value and is therefore only poorly soluble (e.g. the potato protein EMVITAL K5), the protein dispersion is neutralized by adding a 1% NaOH solution (e.g. 1.96 g 1% NaOH per g protein) before it is mixed with the polysaccharide or the oil phase. Prior to use, it may be recommendable to filter the P solution under sterile conditions, e.g. using a 0.2 μm ceramic membrane at 4 MPa.
A⁴: Using a stirrer, the aqueous P solution is slowly mixed into the aqueous PS solution.
A⁵: Under continuous stirring at 1,500 rpm, the oil phase is mixed into the aqueous P-PS phase and subsequently emulsified, for example using a rotor/stator dispersing unit (CAT-X620, M. Zipperer GmbH/Staufen), at about 20,500 to 24,000 rpm and for 15 sec to 1 min. In the laboratory scale, the addition of the oil phase is carried out dropwise within 20 sec using a Pasteur pipette or slowly using a 5 ml macroliter pipette. In the process system, the emulsion is produced by slowly adding the pre-dosed oil portion via a suction tube.
A⁶: Under laboratory conditions, the fine dispersion of the emulsion using the high-pressure emulsifying device EmulsiFlex C5 (AVESTIN, Canada) at 20 to 80 MPa, preferably at 50 MPa, or using other suitable pressure emulsifying devices (e.g. the laboratory pressure homogenizer HH 20 (Wissenschaftlicher Gerätebau, Zentralinstitut für Ernährung, DE 195 30 247 A1) at 8 MPa is subsequently carried out. The average size of the oil drops in the emulsion is about 1 μm±0.2.

In the large-scale, induction and finely dispersing the oil phase into the aqueous P-PS phase can alternatively also be carried out in batches, for example using the vacuum processing plant FrymaKoruma MaxxD 200 (FrymaKoruma GmbH, Neuenburg, Germany), which operates based on the principle of gear rim dispersion (gear rim rotor and stator) and is capable of generating highly viscous emulsions having a particle size of x₅₀ 1.2 to 2.5 μm. This particle size is sufficient for the production of food products having a higher viscosity, in particular where the manipulation of consistency is desired.

Variant B
B¹: =A¹.
B²: Polysaccharide (PS) is stirred into the oil phase using a stirrer, preferably equipped with a dispersing gear rim, at 1,300 rpm for about 15 min and dispersed such that an oil-PS-mixture is obtained.
B³: as A³, with the exception that the proportion of water for dissolving the proteins amounts to 100% of the total water volume.
B⁴: As described in A⁵, the oil-PS-mixture is incorporated into the aqueous P-phase and is emulsified. For generating the emulsion it is important to carry out the dispersing process swiftly (within a few seconds) as the viscosity of the continuous phase will considerably increase immediately upon increase of the drop surface (m²/ml oil), depending on the polysaccharide proportion contained in the oil. The emulsifying process therefore must be carried out and being finisched by having a high polysaccharide content within the oil, before the emulsion will lose its flowability owing to an excessively high viscosity.
B⁵ as specified in A⁶.

Variant C
C¹: =A¹=B¹
C²: =A² and B², wherein in each case only a part of the total amount of polysaccharide (PS) is employed according to Variants A and B, respectively.
C³: =A³
C⁴: =A⁴
C⁵: =A⁵, wherein only one part of the total amount of polysaccharide (PS) is employed according to Variant A. Preferably, the amount employed plus the amount of PS employed in step C² equals the total amount that would be employed in Variants A and B, respectively.
C⁶: =A⁶

Obtainable Emulsion (PPS)

Basically, the emulsion obtained has an acidic or neutral pH value and should have a particle size of x₅₀<10 μm, preferably of <1.5 μm. If required, the emulsion can be adjusted to the desired pH value prior to further processing, for example by means of acidification with 0.1% by weight of citric acid (10% solution), lactic acid or ascorbic acid. The acid is added slowly while stirring.

The methods according to variants B and C allow for the production of emulsions having a high oil content and a very high polysaccharide content. Such emulsions are particularly suitable for compositions and formulations having a low water content, for example of less than 50% by weight of water.

Optionally, further components such as polyols, flavoring agents, coloring agents, preservatives and/or active ingredients can be added to the emulsion while stirring. In this case, subsequent emulsification may be required. Preferably, the addition of further components is omitted.

PPS may be identified by examining the prevention of oil drop aggregation upon decreasing the pH value (particle size determination with and without the addition of sodium dodecyl sulfate) and by measuring pH value and phase stability upon prolonged periods of storage (stability versus separation). PPS according to variants B and C may additionally be identified by the presence of polysaccharide in the oil phase; see also the subsequent general description of the method according to the present invention.

Preparation of the Formulations

In one embodiment, the emulsion having a liquid and viscous consistency is employed by slowly mixing it with a flowable to liquid basic material that preferably has an acidic pH value, such as dressings or buffer solutions for, e.g., biologically active proteins, or it can be immediately employed or processed in order to obtain the desired product. While most applications comprise advantageously mixing PPS into the respective basis, it has been proven to be advantageous to slowly mix highly acidic solutions into PPS, so that the pH value will not be decreased too rapidly.

In another embodiment, the emulsion having a creamy to pasty consistency is mixed into a viscous, pasty, spreadable or doughy basic material that preferably has a neutral pH value in order to obtain the respective product. If required, the pH value of the basic food material can be decreased prior to further processing, for example by means of acidification with an acid that is also otherwise conventional for use in the respective product, such as lactic acid or citric acid. Alternatively, the emulsion itself will constitute the matrix for the product, for example in the form of a salve or cream, into which active ingredients are incorporated that are suitable for the respective application. Of course, this may also be carried out already during the production process of the emulsion, for example as part of the oil, protein or polysaccharide component.

PPS may readily be dried in order to be mixed with further components such as food components, active ingredients or building materials on dry basis. A variety of drying methods may be employed; see also Examples 12 and 13. The suitable method is to be selected according to the specific requirements with respect to intermediate or final products. In case convenience characteristics (e.g. a easy solubility) are desired and are not already provided by the selected drying method, further methods such as, for example, agglomeration must be carried out subsequently. The dried emulsion is then mixed into a dry or dried composition that contains further components in order to obtain the respective product. According to the embodiments, the emulsion may alternatively also be admixed together with the further components of the composition and subsequently dried or freeze-dried.

FIG. 2: Schematic representation of the production of the emulsion employed in the method according to the present invention by reference to PPS7 (A) and PPS20 (B) as well as various protein and polysaccharide sources. FIG. 2C illustrates the production of PPS24 by reference to the use of whey protein hydrolysates and apple pectin extract. FIG. 2D illustrates the production of PPS using vegetable oil or fat. FIG. 2E illustrates an embodiment of the production of PPS using vegetable oil and cream, respectively.

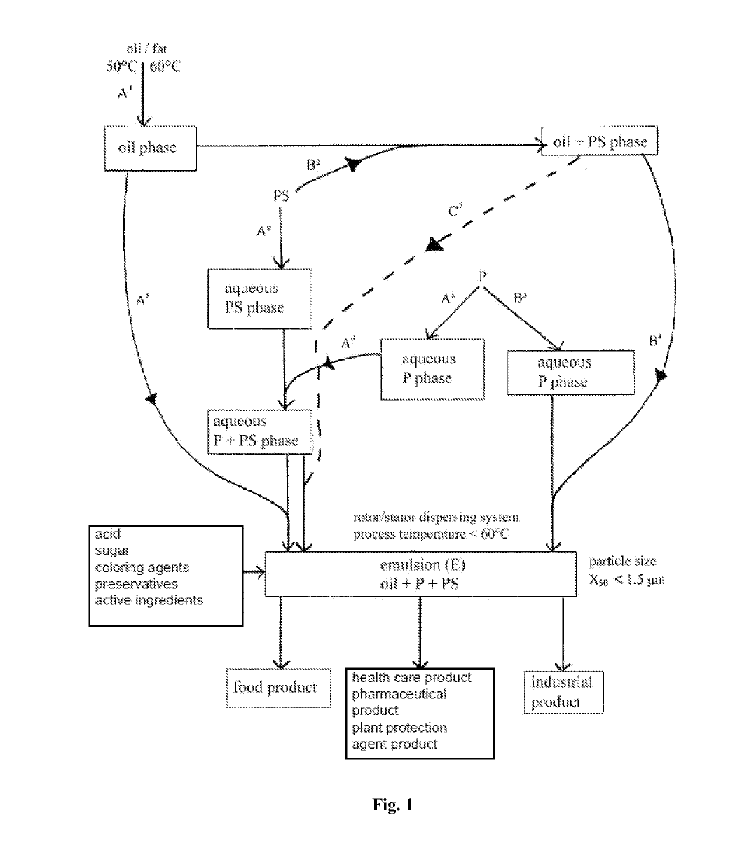

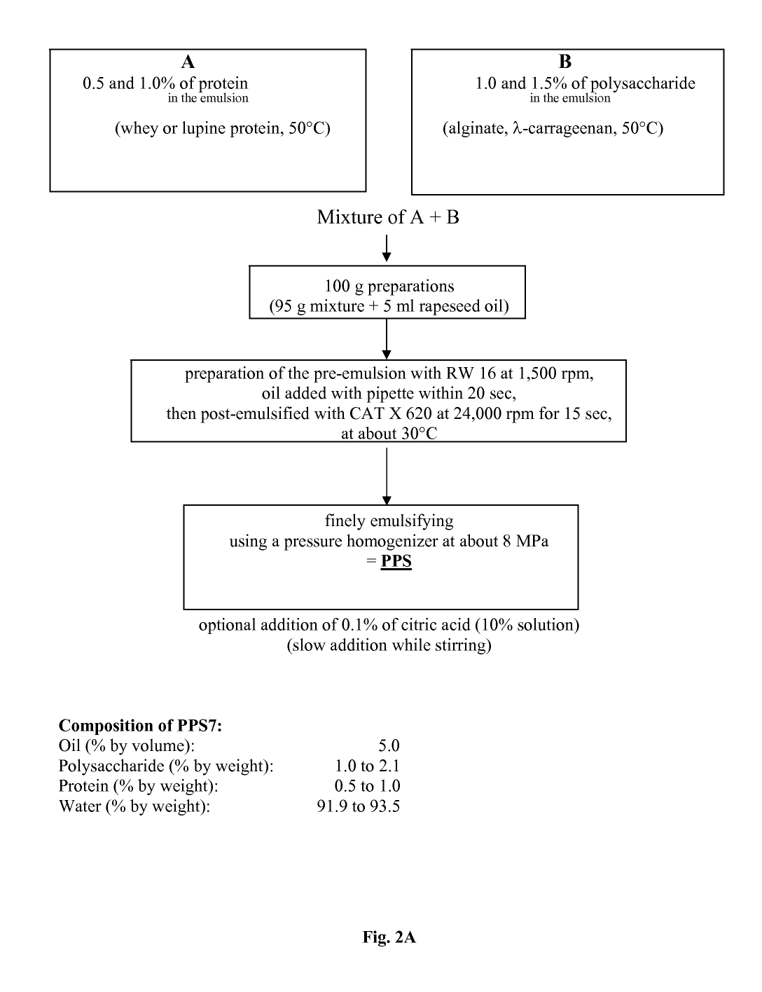

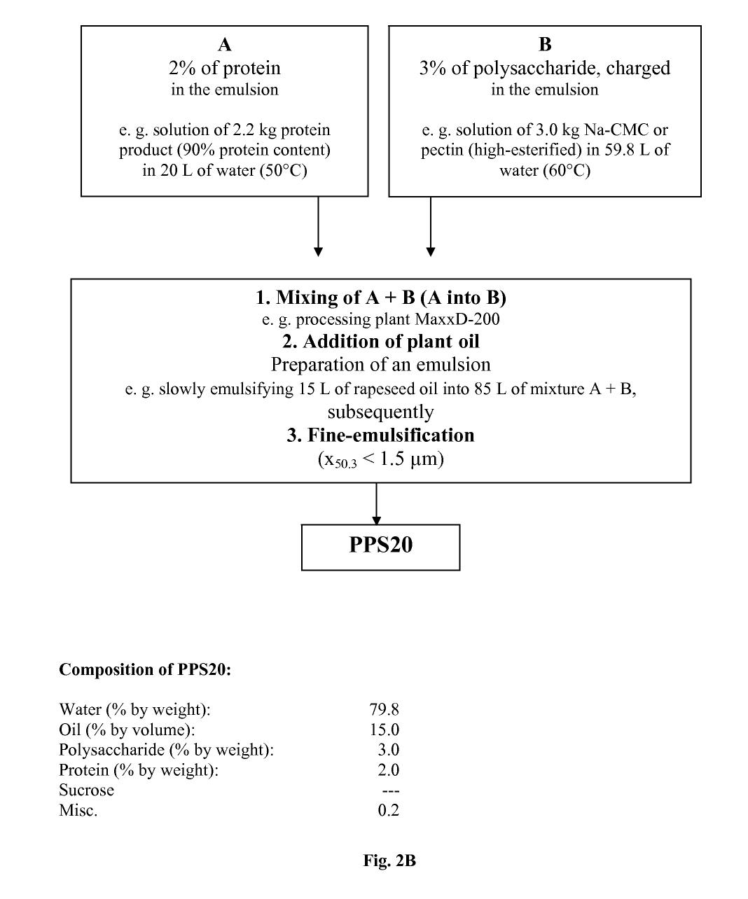

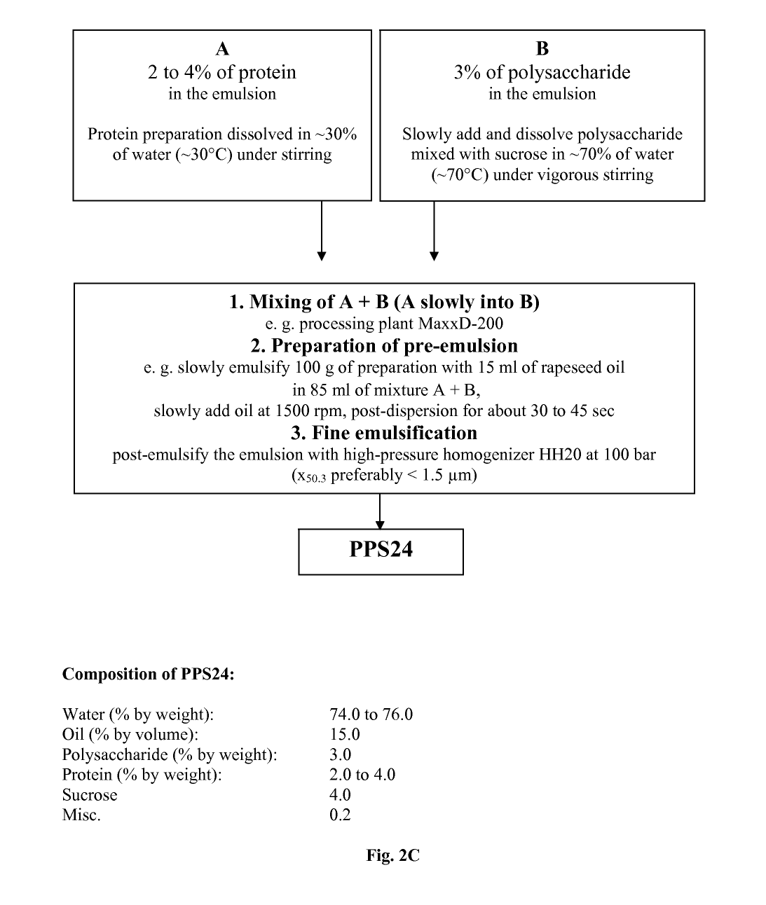

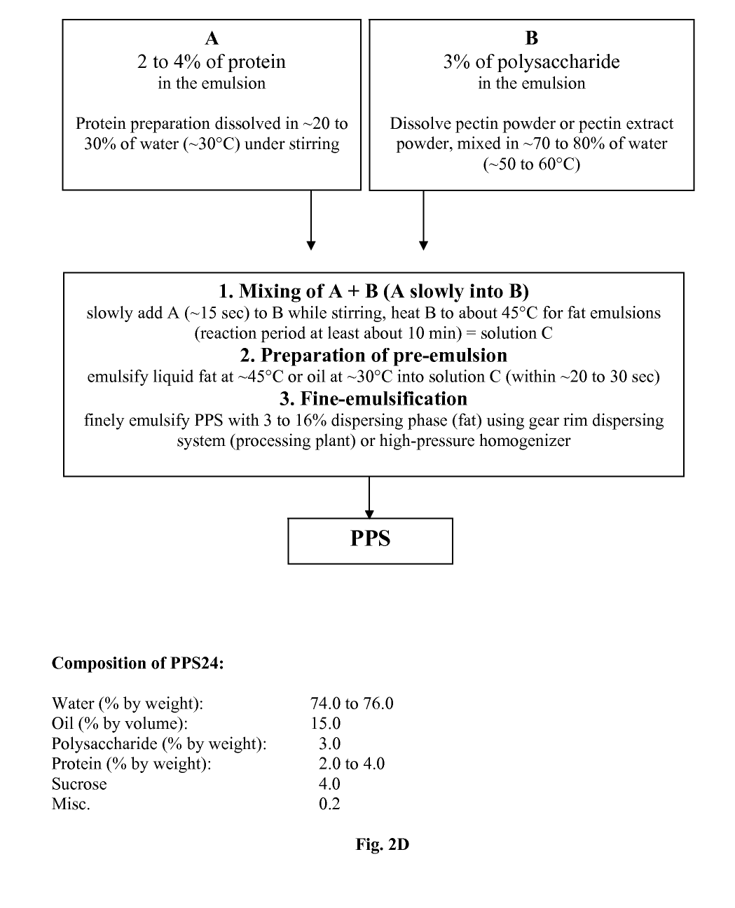

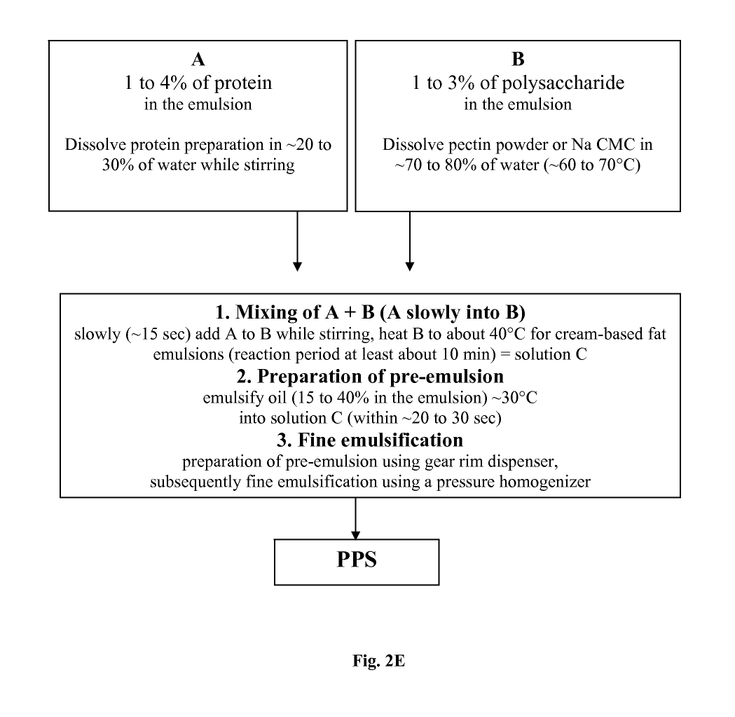

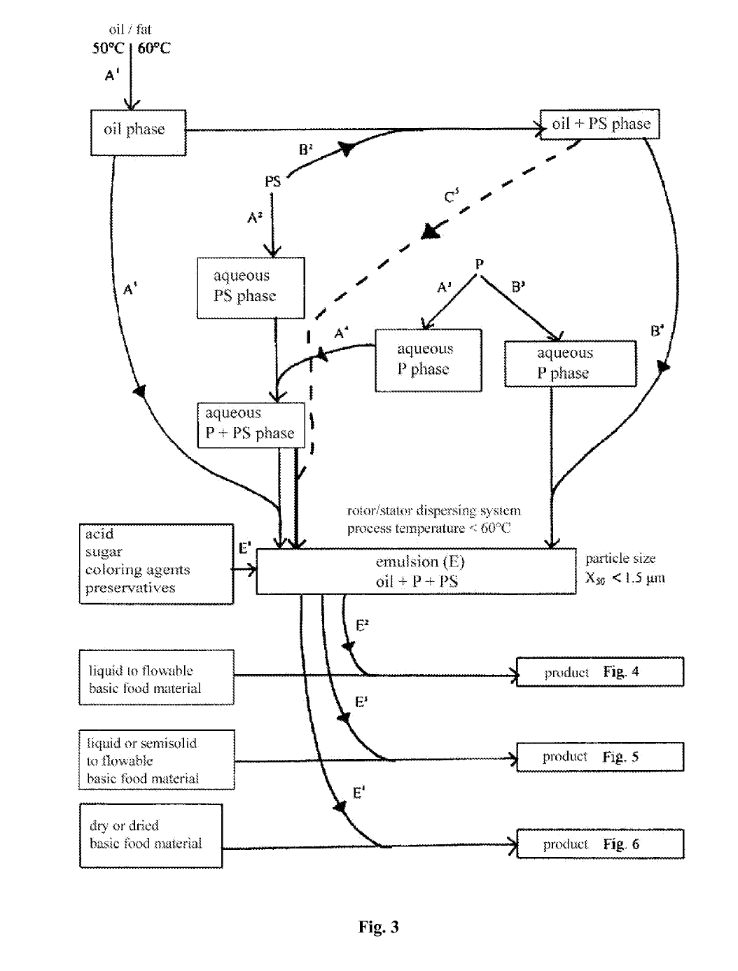

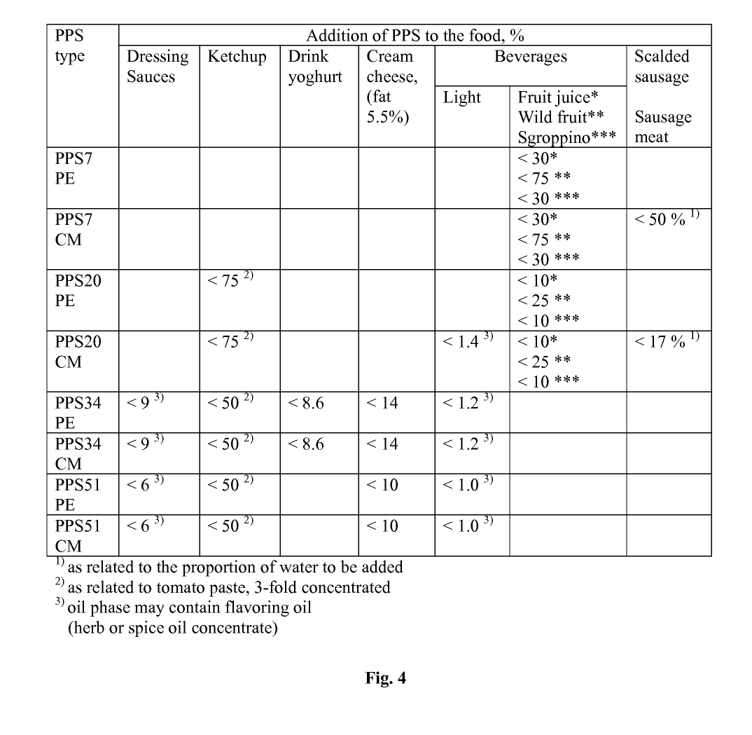

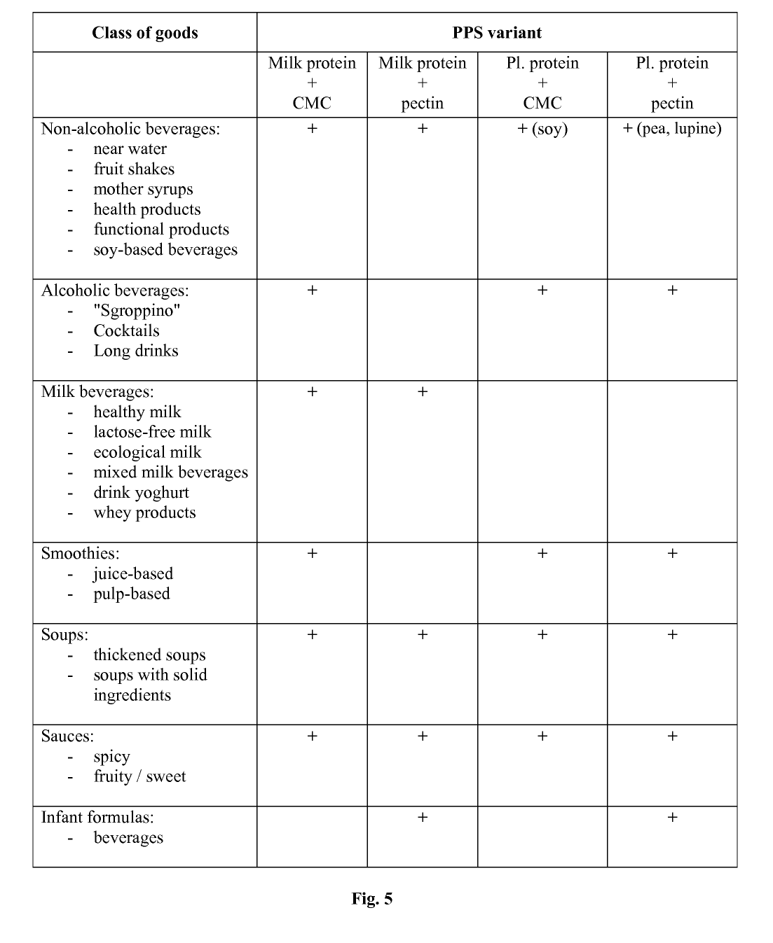

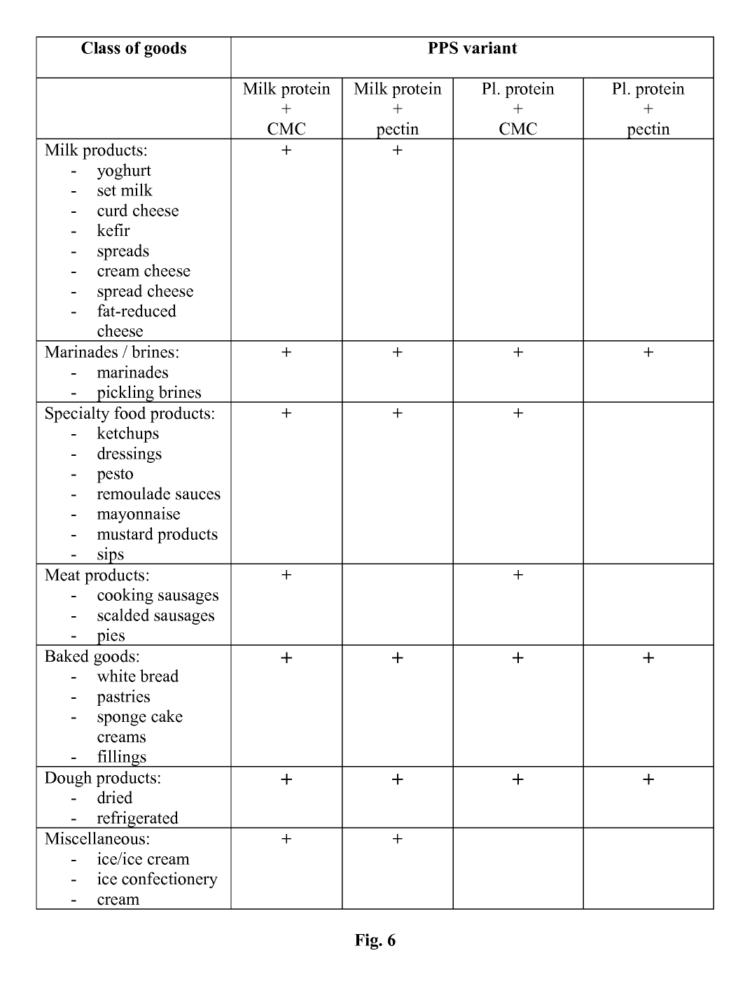

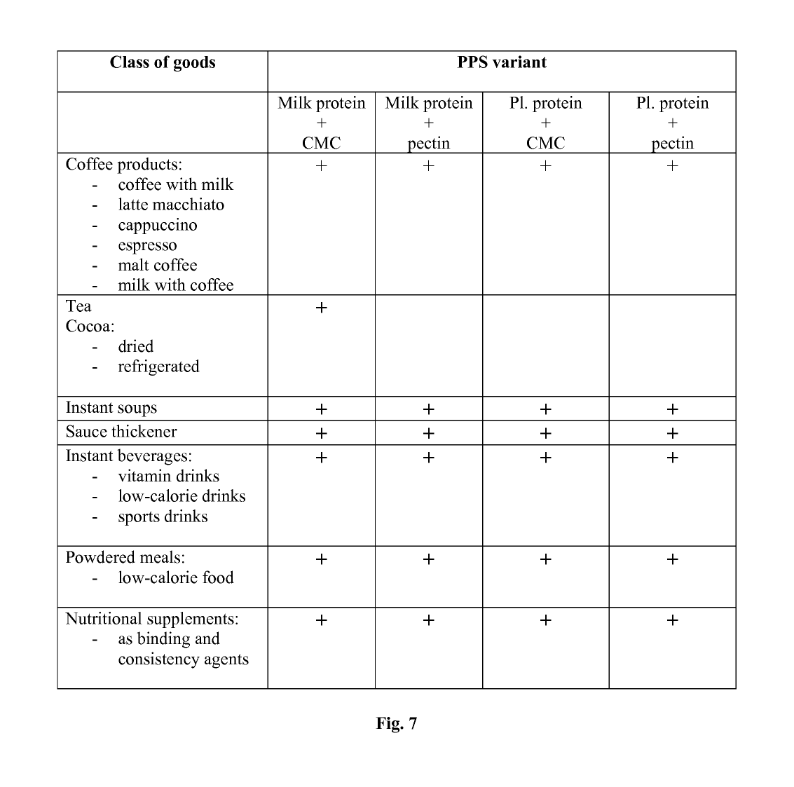

FIG. 3: Schematic representation of the method according to the present invention for producing a food product that is altered with respect to its sensory, functional and/or nutritional physiological characteristics, including the preferred production of the oil-in-water (O/W) emulsion (herein also referred to as “PPS”). For a description of the variants A and B see the above legend of FIG. 1.

Adjustment and Analytics of the Emulsion
E: Basically, the emulsion obtained has a neutral pH value and should have a particle size of x₅₀<10 μm, preferably of <1.5 μm. If required, the emulsion may be adjusted to the desired pH value prior to further processing, for example by means of acidification with 0.1% by weight of citric acid (10% solution), lactic acid or ascorbic acid. The acid is added slowly while stirring. The methods according to variants B and C allow for the production of emulsions having a high oil content and a very high polysaccharide content. Such emulsions are particularly suitable as additives for foods having a low water content, for example of less than 50% by weight of water.
E¹: Optionally, further components such as polyols, flavoring agents, coloring agents and/or preservatives may be added to the emulsion while stirring. In this case a subsequent emulsification may be required. Preferably, the addition of further components is omitted. For producing the respective food products, the PPS variants given in the following Tables, Examples and Figures are preferably used in the indicated ranges of concentration.

PPS may be identified by examining the prevention of oil drop aggregation upon decreasing the pH value (particle size determination with and without the addition of sodium dodecyl sulfate) and by measuring pH value and phase stability upon prolonged periods of storage (stability versus separation). PPS according to the variants B and C may additionally be identified by the presence of polysaccharide in the oil phase; see also the subsequent general description of the method according to the present invention.

Production of the Foods
E²: The emulsion is employed by slowly mixing it with a flowable to liquid basic food material that preferably has an acidic pH value, such as juices, tomato paste and dressings, or it can be immediately employed as a food or further processed in order to obtain the respective food product; see for example the table of FIG. 6. While most applications conveniently comprise mixing PPS into the respective basic food material, it has proven advantageous to slowly mix highly acidic foods (e.g. wild fruit juices) into PPS, so that the pH value will not be decreased too rapidly.
E³: The emulsion is mixed into a viscous, pasty, spreadable or doughy basic food material that has a neutral pH value in order to obtain the respective food product; see for example the table of FIG. 5. If required, the pH value of the basic food material may be decreased prior to further processing, for example by means of acidification with an acid that is also otherwise conventional for use in the respective product, such as lactic acid or citric acid.
E⁴: PPS may readily be dried in order to be mixed with food components on a dry basis. A variety of drying methods may be employed; see also Examples 25 and 26. The suitable method is to be selected according to the specific requirements with respect to intermediate or final products. In case convenience characteristics (e.g. a easy solubility) are desired and are not already provided by the selected drying method, further methods such as, for example, agglomeration must be carried out subsequently. The dried emulsion is then mixed into a dry or dried basic food material in order to obtain the respective food product; see for example the table of FIG. 7. According to the embodiments of E³, the emulsion may alternatively also be mixed into the basic food material and subsequently dried or freeze-dried.

FIG. 4: Fields of application of PPS with whey protein in combination with sodium CMC (CM) or high-esterified pectin (PE) with an indication of the PPS variants and ranges of concentration.

FIG. 5: Table listing liquid and flowable foods according to the present invention.

FIG. 6: Table listing flowable, viscous, pasty, spreadable, doughy and firm foods, or their respective starting basis according to the present invention.

FIG. 7: Table of liquid and flowable foods according to the present invention.

### DETAILED DESCRIPTION OF THE INVENTION

In general, the present invention relates to a means, i.e. an emulsion (hereinafter also referred to as “PPS”), that is suitable in the production of a plurality of products that are characterized in being creamy, lubricious and/or rich in texture and, with respect to food products, produce a full-bodied mouthfeel and meet nutritional physiological requirements. Correspondingly, the present invention relates to a method for producing a phase-stable oil-in-water (O/W) emulsion having a dry mass of between 5 and 60% by weight and containing, as related to the total weight of the emulsion, the following components:

(i) 0.2 to 10.0% by weight of protein;

(ii) 0.3 to 10.0% by weight of polar polysaccharide;

(iii) 0.1 to 60.0% by weight of a fat/oil component;

(iv) 0 to 30.0% by weight of a polyol; wherein

a phase that essentially consists of the fat/oil component (oil phase) (iii) and is optionally mixed with the polysaccharide (ii) or with a portion thereof is dispersed in an aqueous phase that contains the protein (i) and optionally the polysaccharide (ii) or a portion thereof, and wherein said emulsion is subsequently finely emulsified. The particle size of the dispersed oil or fat drops in maximum dispersion is preferably x_{50.3}≦10 μm (volume-related median value). Preferably, the amount of water contained in the liquid or flowable material (including any amount of water present in other ingredients) is in a range between 20 and 95% by weight, more preferably between 30 and 80% by weight. Conventionally, the dry mass reduction of PSS below 60% by weight is essentially achieved by reducing the oil or fat content, whereas the respective proportion of protein and polysaccharide remains essentially constant.

The emulsion according to the present invention is characterized by aggregation and phase stability as well as a creamy consistency. The present invention is based on the surprising observation that a plurality of products can be altered and produced using an emulsion that essentially consists of only three components, i.e. protein, polar polysaccharide and liquid lipid (oil, liquid fat); see also the products according to the Examples, which could not be produced with a satisfactory result using the currently conventional oil/fat emulsions and emulsifiers and the like due to flocculation of the dispersed fat phase, phase instability or water separation. The object of the present invention is mainly described with reference to the use of an emulsion containing pectin (PE), sodium carboxymethylcellulose (CMC) and sodium alginate (Alg) as polysaccharide component and whey protein (WPI) and lupine protein (Lup) as protein component. Unless otherwise indicated, the embodiments described for this purpose equally comprise embodiments in which the employed emulsion contains alternative or equivalent polysaccharide and protein components. It is further understood that an embodiment of the present invention as described herein or the characteristics thereof may also be combined with one or more further embodiments and characteristics thereof as described herein, unless the respective embodiments mutually exclude one another.

In principle, the emulsion employed in the methods of the present invention can be prepared according to two or three methods, as is outlined in FIGS. 1 and 3 and explained in the legends of FIGS. 1 and 3. In one embodiment (variant A) the emulsion can be obtained by dispersing a phase that essentially consists of the fat/oil component (oil phase) in an aqueous phase that contains the protein and polysaccharide; see also Example 1 and FIG. 2. In another embodiment (variant B) the emulsion is obtained by mixing the oil phase with the polysaccharide and subsequently dispersing it in the aqueous phase that contains the protein; see also Example 2. In another embodiment (variant C) a portion of the intended amount of polysaccharide is introduced into the oil phase according to variant B and the oil and polysaccharide phase is dispersed in the aqueous phase that contains protein and polysaccharide according to variant A, wherein preferably the amount of polysaccharide in the aqueous phase is correspondingly adapted to the amount of polysaccharide that is already contained in the oil phase.

A method for producing an emulsion according to variant A is described in the German patent application DE 10 2006 019 241 A1, wherein in a first step an oil phase and a biopolymer mixture, consisting of an aqueous phase containing proteins (e.g. whey proteins) and a polysaccharide (e.g. sodium carboxymethylcellulose or amidated low-esterified pectin), are mixed without the addition of acid to yield a neutral emulsion and in a subsequent step the pH value of said emulsion is decreased upon the addition of an acidic aqueous phase. The disclosure content of DE 10 2006 019 241 A1, in particular of the Examples for producing an emulsion, is hereby incorporated by reference in the present description. Document DE 10 2006 019 241 A1 as well as the additional patent application DE 10 2006 058 506 A1 based thereon, however, describe the use of the emulsion described therein merely as an additive for acidic cold beverages with and without alcohol. In one embodiment of the present invention, the emulsions and/or methods for producing cold beverages that are described in DE 10 2006 019 241 A1 and DE 10 2006 058 506 A1 are explicitly excluded. In another embodiment of the present invention, an emulsion according to DE 10 2006 019 241 A1 or DE 10 2006 058 506 A1 is produced, wherein a vegetable protein is employed instead of whey proteins, however.

Furthermore, in contrast to the method according to document DE 10 2006 019 241 A1, decreasing the pH value of the emulsion for further use in the production of the desired product is not required according to the present invention. In the embodiments of the method according to the present invention an acidic or pH-neutral emulsion is employed, wherein the pH value is defined by the polysaccharide employed and by the buffer capacity of the protein. Whereas in the embodiment of the present invention using sodium CMC the pH value of the emulsion is in a neutral range (pH 6.9 to 7.6), the pH value of the emulsions produced with pectin (e.g. high-esterified pectin) is between 4.2 to 5.0. Thus, in a preferred embodiment of the method according to the present invention PPS is produced without decreasing the pH value by the subsequent addition of acid.

For achieving the desired effects of the emulsion according to the present invention it has proved to be advantageous to separately dissolve the protein and polysaccharide components in water before subsequently mixing them. Preferably, an aqueous protein-polysaccharide phase is prepared by mixing a solution containing the protein into a solution containing the polysaccharide; see also the schematic representation of variant A in FIGS. 1 and 3.

In particularly preferred embodiment of the method according to the present invention, the polysaccharide employed in the emulsion is a pectin product. In a particularly preferred embodiment, the pectin employed is high-esterified pectin. In a further particularly preferred embodiment of the method according to the present invention, the polysaccharide employed in the emulsion is sodium carboxymethylcellulose (CMC).

In one embodiment of the present invention, the oil phase of the emulsion contains a flavoring oil. If an emulsion prepared according to the present invention is intended, at a very low proportion of the emulsion, for flavoring foods or for scenting cosmetic products that contain a flavoring oil, the emulsion employed should be stable even at a high dilution. As such flavoring oils usually have a lower density than the continuous phase (e.g. dispersed phase <0.930 g/cm³; continuous phase >1.000 g/cm³) not only a very small drop size of the dispersed oil, but also the prevention of drop aggregation as well as an additional increase of the density of the dispersed phase are required. The increased density of the oil phase, which should be adapted to the density of the surrounding phase, then results, for instance in liquids, for sufficient state of suspense of the dispersed drops and thus in a stable turbidity, for example of a tincture or lotion.

In case of a strong dilution of the emulsion according to the present invention, in particular in liquid and flowable products, it is preferably to be ensured that the oil phase of the emulsion has a density of more than 0.995 g/cm³. The German patent application DE 10 2007 026 090 A1 describes the production of turbid light beverages, wherein an emulsion is employed that consists of an oil phase and an aqueous phase that contains protein and polysaccharide, wherein the oil phase of the emulsion contains at least one flavoring oil that is preferably produced from processed and peeled oil seeds with parts of herb and/or spice plants and/or fruits and has a density of more than 0.850 to 1.135 g/cm³, preferably of 0.995 to 1.020 g/cm³. As described in DE 10 2006 019 241 A1, such an emulsion is prepared from an oil phase and an aqueous phase, wherein in a first step oil and a biopolymer mixture, consisting of an aqueous phase that contains proteins, preferably whey proteins, and a polysaccharide, preferably sodium carboxymethylcellulose or amidated low-esterified pectin, are mixed without the addition of acid to yield a neutral emulsion and in a subsequent step the pH value of said emulsion is decreased upon its addition to an acidic aqueous phase.

In contrast to the method described in document DE 10 2006 019 241 A1, one or more flavoring oils that are produced from processed and peeled oil seeds with parts of herb and/or spice plants and/or fruits and/or further, preferably vegetable flavoring oils, are employed for preparing the emulsion. Prior to preparing the emulsion, the flavoring oils are mixed with a glycerol ester of the fractionated vegetable fatty acids C₈ and C₁₀ that is linked with succinic acid and has a density of 1.00 to 1.02 g/cm³ (e.g. Miglyol® 829, Sasol Germany GmbH) and are increased in density. Alternatively, it is also possible according to the present invention to employ further oil or fat components that are capable of increasing the density of the oil phase that contains the flavoring oils in a range from 0.850 to 1.135 g/cm³, preferably from 0.995 to 1.020 g/cm³. In one embodiment of the method according to the present invention, the use of an emulsion as described in document DE 10 2007 026 090 A1 for the production of beverages, in particular light beverages, is excluded. In another embodiment of the method according to the present invention, an emulsion is used that is produced according to document DE 10 2007 026 090 A1, with the exception that a vegetable protein is employed instead of whey proteins.

In a further embodiment of the present invention, the aqueous phase of the emulsion employed contains a polyol. For instance, the addition of 1 to 3% of a polyol like crystal sugar facilitates the dispersion of sodium CMC and reduces the heat sensitivity of the whey protein. For improving the dispersibility of powders that are prone to clumping (when stirred into water), it is common use in the industry to mix them with further substances that are less prone to clumping. It is thus recommended to mix pectin, or also sodium CMC, with sugar in case the formulation contains crystal sugar. Although the presence of a polyol is basically not required when using a processing plant for producing an emulsion, it may be desirable in some embodiments of the present invention that the emulsion employed contains at least 1% of a polyol, i.e. sugar (e.g. sucrose, sorbitol or isomalt), as these sugars effect an additional technofunctionality. Besides improving the freezing/thawing behavior of the emulsions (prevention of oil leading of the emulsion in the freezing process), sorbitol also acts to reduce the water activity (improved micro biological stability) and isomalt to reduce the hygroscopicity of dried emulsions. The presence of isomaltulose (palatinose) in the emulsion employed is also advantageous in the manufacture of food products that are desired to exhibit a more sustained provision of energy (sports beverages).

In a further embodiment of the present invention, the oil phase of the emulsion employed contains a weighting agent, e.g. sucrose-acetate-isobutyrate (SAIB). The presence of a weighting agent can be advantageous in case the emulsion is to be used as a flavoring emulsion at a high dilution. Instead of SAIB, succinic acid esters from fatty acid glycerides, as described in DE 10 2007 026 090 A1, or a polysaccharide that is bound in the oil phase, see DE 10 2007 057 258.3 as previously discussed and Example 2, may also be used as weighting agent.

In a preferred embodiment of the present invention, the emulsion employed is essentially free of synthetic emulsifiers, weighting agents and/or polyols. When producing emulsions using the processing plant by FrymaKoruma (ROMACO, FrymaKoruma GmbH, Neuenburg, Germany), for instance, the presence of a polyol in the emulsion is not required as the above-discussed clumping does not occur owing to the strong shear forces. In a further preferred embodiment of the present invention, the emulsion employed is essentially free of flavoring oil components, flavoring agents, coloring agents, preservatives, acids and/or further excipients.

In a particularly preferred embodiment of the present invention, the protein used in the emulsion is a vegetable protein. As discussed in the above, documents DE 10 2006 019 241 A1, DE 10 2006 058 506 A1 and DE 10 2007 026 090 A1 describe the production of an emulsion with the exclusive use of whey proteins that is intended for the exclusive use in the manufacture of beverages. Only within the scope of the present invention, experiments were conducted in which it was surprisingly shown that emulsions that are, for example, produced according to a method as described in DE 10 2006 019 241 A1 or DE 10 2007 026 090 A1, but with vegetable proteins instead of whey proteins, exhibit a very high phase and acid stability and are ideally suited for being mixed into a plurality of products, in particular into purely plant-based products and products in which the meat content is preferably to be reduced, like fried sausages and burgers, for example vegetable burgers.

According to the present invention it is thus advantageously possible to produce emulsions that contain vegetable proteins like lupine proteins instead of whey proteins, whereby, for instance, allergic reactions to products containing whey proteins, which consumers might suffer from, can be avoided with the use of said emulsions. Furthermore, the use of vegetable proteins such as pea protein, soy protein or potato protein in the emulsion allows for influencing the amino acid composition and thus facilitates the provision of a food having altered nutritional physiological characteristics. In addition it is possible to produce purely plant-based products in conjunction with the use of a vegetable oil for the oil phase and a plant polysaccharide such as pectin in the emulsions produced according to the method of the present invention. The needs of specific consumer groups can thus easily and suitably be met with respect to the raw materials employed. Thus, in a particularly preferred embodiment of the method according to the present invention for producing the emulsion, the components are essentially of plant origin.

In a further preferred embodiment of the method according to the present invention for producing the emulsion, the polysaccharide employed is sodium carboxymethylcellulose (CMC) or pectin (PE). Although pectin and sodium CMC are carbohydrates, they are not accounted for in the calculation of nutritional value as they are purely dietary fibers that are not directly metabolized. In some embodiments, nutritional information may be found for pectin (e.g. 100 kcal or 425 kJ per 100 g) in case the pectin contains sugar for standardizing purposes (for providing a consistent gel strength). The addition of sugar to pectin varies greatly; in the above-mentioned example of nutritional information the sugar content is about 25%. With the use of sodium CMC, any further addition of carbohydrates for adjusting the desired characteristics is preferably omitted.

In one embodiment of the method according to the present invention, the pectin employed for producing the emulsion is high-esterified (HE) or amidated low-esterified (P-am) pectin. P-am is suitable for generating a very stable turbidity in light beverages. If, however, a wider use of the flavored PPS emulsion in calcium-containing products is intended, the reaction of calcium and pectin may result in undesired alterations of the product (flocculation, gel formation, phase separation and the like). This also applies to mixing the emulsions into milk products. Thus, in another embodiment, the pectin employed in the emulsion is high-esterified pectin.

In the method according to the present invention for producing the emulsion, the ratio of protein and polysaccharide ranges from 4:1 to 1:4, wherein the emulsion preferably essentially contains 0.75 to 5.0% by weight of protein, 0.5 to 2.5% by weight of polysaccharide and 5.0 to 50.0% by weight of a fat/oil component. In case a higher polysaccharide (e.g. pectin) content is desired, the polysaccharide can be added to the oil phase prior to the emulsion production process, according to embodiments B or C as illustrated in FIGS. 1 and 3 and explained in the accompanying legends.

As already explained in the above, the present invention is based on the surprising observation that a plurality of products can be altered and produced using an emulsion that essentially consists of only three components, i.e. protein, polar polysaccharide and neutral vegetable oil; see also the Examples. In a particularly preferred embodiment of the present invention, the emulsion thus essentially consists of the components protein, polysaccharide and oil. Particularly preferred compositions are listed in the following Table 1.

TABLE 1
Preferred compositions of the employed emulsion
according to the present invention, including typification
under the designation of “PPS” according to the
dry mass content of the emulsion

| | PPS type | | | |
|---|---|---|---|---|
| Composition (% by weight) | 7 | 20 | 34 | 51 |
| Protein | 1 | 2 | 2 | 3 |
| Polysaccharide PE (sodium CMC) | 1 | 3 | 2 | 3 (2) |
| Oil | 5 | 15 | 30 | 45 |
| Water | 93 | 80 | 66 | 49 |

Further preferred PPS compositions can also be taken from the Examples and Figures. The absolute contents of protein and polysaccharide as well as their ratios depend on the desired application (in particular, the viscosity is also determined by polysaccharide content) and thus vary correspondingly, wherein in the emulsion referred to as PPS 7 preferably both components combined are present at 1.5 to 2.5% by weight, in PPS 20 from 3.5 to 6.0% by weight, in PPS 34 from 3.0 to 5.0% by weight and in PPS 51 from 4.0 to 7.0% by weight. The content of fat/oil components preferably remains unaltered, wherein deviations of up to 10% are also tolerated. Preferably, the ratio of protein and polysaccharide in the aqueous phase ranges from 1:1 to 1:1.25.

The above table shows different ratios of protein and polysaccharide based on the fact that the protein content must increase with the increasing oil content. As the drop surface per ml of oil increases, a higher protein proportion is required for interface occupancy. If the percentage per m² surface/ml oil is too low, the drops will lose their coalescence stability. On the other hand, the water content in the emulsion is reduced and the emulsion will lose its flowability if the sodium CMC or pectin concentration in the aqueous phase is too high. Thus, rheology or pasty consistency can be adjusted by altering the pectin or sodium CMC content.

In a particularly preferred embodiment of the present invention, the emulsion employed has essentially one of the compositions listed in Table 2.

TABLE 2
Preferred compositions of the employed emulsion according to
the present invention, including typification under the designation
of “PPS” according to the dry mass content of the emulsion

| Ingredients | PPS7 | | PPS20 | | PPS34 | | PPS51 | |
|---|---|---|---|---|---|---|---|---|
| per 100 g | 1a | 1b | 2a | 2b | 3a | 3b | 4a | 4b |
| Sodium CMC | 1.0 | — | 3.0 | — | 2.0 | — | 2.0 | — |
| 1000GA | | | | | | | | |
| Pectin AS 501 | — | 1.0 | — | 3.0 | — | 2.0 | — | 3.0 |
| Whey protein | 1.0 | 1.0 | 2.0 | 2.0 | 2.0 | 2.0 | 3.0 | 3.0 |
| Vegetable oil | 5.0 | 5.0 | 15.0 | 15.0 | 30.0 | 30.0 | 45.0 | 45.0 |
| Water | 93.0 | 93.0 | 80.0 | 80.0 | 66.0 | 66.0 | 50.0 | 49.0 |
| Total | 100.0 | 100.0 | 100.0 | 100.0 | 100.0 | 100.0 | 100.0 | 100.0 |

In the method according to the present invention, the mass ratio of protein and polysaccharide in the emulsion employed may vary by 1:1, as is disclosed in DE 10 2006 019 241 A1 (1:0.25 to 1:2.0). Essentially, this applies to a combination of protein with pectin and sodium CMC, whereas for combinations of protein with further polysaccharides the conduct of corresponding preliminary experiments is recommended. Preferably, the dry mass content of the emulsion employed ranges from 7.0 to 55.0% by weight. In a preferred embodiment, the dry mass content is 25% or optionally up to 50% of a standard formulation.

In a preferred embodiment, the emulsion preferably contains more than 1.5% by weight of protein and/or more than 1.0% by weight, preferably more than 1.5% by weight of polysaccharide, wherein the total dry mass (DM) is preferably about 20% by weight or more. As indicated in the previous Tables 1 and 2, the emulsion will in this case contain preferably at least 2.0% by weight of protein and/or at least 2.0% by weight of polysaccharide.

For the PPS emulsions indicated as standards in Table 2, the application ranges and amounts for the method according to the present invention are given in the Table of FIG. 3. The particle size of the emulsion that can be obtained by the method according to the present invention preferably is x_{50.3}<5 μm, even more preferably x_{50.3}<1.5. This size of particles is sufficient if the emulsion is to be employed in products having a higher viscosity, in particular with the aim of influencing the consistency. Such emulsions having a particle size of <1.5 μm additionally yield a higher degree of turbidity when diluted and exhibit a slower creaming velocity. Emulsifying experiments conducted in a processing plant show that under certain emulsifying conditions also the principle of gear rim dispersion may also yield even smaller drops in an emulsion.

In a preferred embodiment, the emulsion according to the present invention, when in sealed packaging and cryopreserved at −18° C., is storable and stable over a long time period, i.e. for at least three months, preferably six months, in particular preferably 12 months and advantageously 24 months, i.e. there will not occur any phase separation prior to use. The wet product and preferably also the dry product should be stored in a cool place and protected against direct UV irradiation prior to use.

In this context, the emulsion according to the present invention can be used as thickening agent, suspending agent, binding agent, water retention agent and for reducing the fat content without further processing. However, for economic reasons it is required that the emulsions are processed and marketed in a dried state and in the form of an essentially dry composition. Although the drying process may be conducted according to any suitable method known to the person skilled in the art, the method of drum drying is preferred.

For the production of concentrated foods, in particular of food additives, and for application as an instant product, PPS can, for example, be dried in a spray drier using the standard conditions for milk products. Freeze-drying is also advantageous. In case PPS is supposed to be dried before being added to further components of a formulation, the emulsion is first of all frozen in a freeze-drying step. Herein, it is advantageous that the emulsion has a high freeze/thaw stability in order to prevent a strong crystal formation, which may result in the destruction of the oil drop interfaces and thus cause coalescence of the drops. The freeze stability can be increased by adding a polyol such as sugar, in particular in the form of mono- or disaccharides (as a cryoprotective agent).

This embodiment is particularly advantageous for instant products in which the emulsion employed may effect a whitening of coffee or tea beverages such as to imitate the addition of milk. In prior art instant products, in which milk substitutes are employed for this purpose, this is in particular achieved by combining proteins and low-molecular emulsifiers. In the emulsion employed according to the present invention, the addition of low-molecular emulsifiers can advantageously be omitted.

For the purposes of the present invention, a PPS composition is regarded as dry if its moisture content (free water content) is less than about 20%. Usually, the obtained products are dried to a moisture content of about 5 to 12%. Dry compositions can then be crushed, ground or pulverized to obtain a desired particle size. The skilled person will understand that further drying methods may also be employed, provided that viscosity and moisture content of PPS, respectively, are adapted to the process conditions prior to drying. Depending on the application, the weight proportion of PPS in dry mixtures ranges from 0.1 to 99% by weight, preferably from 2.0 to 98% by weight, particularly preferably from 5 to 90% by weight and in particular preferably from 50 to 80% by weight. Dried products can easily be re-dissolved in water by mixing under high shear strain in order to yield the suitable, aqueous compositions according to the present invention. The addition of water to dry compositions that are essentially purely PPS-based essentially yields the respective original emulsion or, in case larger amounts of water are added, a corresponding dilution of the respective PPS type.

As already explained in the above, the dried compositions according to the present invention have unique characteristics that can be customized for specific end uses by an appropriate selection of ingredients, proportions and processing conditions. Said compositions predominantly hydrate rapidly and yield distributions that are not only smooth and more or less viscous, according to typification, but also have an excellent creaminess and very good film forming characteristics with a low sliding resistance.

Compositions according to the present invention having a higher solid fat content in order to yield viscous pastes at room temperature will become sufficiently thin to be pourable upon heat input. Heated compositions will then again become solid upon cooling. These characteristics are similar to those of a typical meltable fat or shortening. If the biopolymer/oil emulsions are produced with a solid substance content of more than about 30%, the resulting products are prone to be thick and adhesive, which favors their application as coating emulsion or film former and also renders conceivable their application as light adhesives.

According to the desired formulation, a suitable PPS type may be used. PPS7-PE, for instance, is a thin, viscous, odorless and slightly acidic emulsion and is therefore particularly suitable for liquid formulations such as tinctures and lotions, whereas PPS7-CM and PPS20-PE are thicker and more neutral in taste and are thus rather used for gels and flowable matrices for active ingredients contained in capsules. PPS20-CM, being a thick, creamy and only slightly flowable emulsion, as well as PPS34-PE, PPS34-CM, PPS51-PE and PPS51-CM, being tight-creamy, odorless and neutral in taste pastes are particularly advantageous for the production of salves, creams, sealants and the like. In this context it is understood that those PPS types having higher concentrations may be diluted and also employed in liquid formulations. As outlined in the above, the viscosity may also be influenced, beside the use of the desired polysaccharide, also by producing PPS according to variants B and C of the method according to the present invention, by increasing the polysaccharide content in the oil phase. By adjusting the particle size it can also be influenced whether PPS in solid to dry form will be more or less oily. For instance, the results obtained when spray drying PPS have shown that the powders become increasingly dry with a decreasing particle size of the oil drops, i.e. dry at about 1 μm, whereas PPS is more oily and easier to comminute at a particle size of about 5 μm, which is advantageous in the application of PPS as cream, salve or cosmetic powder. The many various characteristics of the compositions according to the present invention thus render them suitable for producing a large number of products in which emulsions are typically employed.

In the food sector, formulations that can be introduced into the compositions of the present invention comprise, without limitation, sour cream, yoghurt, ice cream, cheese, spread cheese, baking mixtures, biscuits, dry-roasted peanut coatings, salad dressings, meat, margarine, powdery shortening or baking mixtures, dough, ready-made gravy and confectionery. For these applications, the compositions may be formulated with a fat content of about 5% to about 60%, as related to the weight of the emulsion. Furthermore, the compositions according to the present invention are suitable as carriers for volatile flavoring and aromatic agents and as low-fat coatings in order to improve the taste and the easy “popping” of popcorn in a microwave device.

In a further aspect, the present invention correspondingly relates to the use of PPS in the production of food and beverage products that are characterized by producing a creamy, lubricious, rich-in-texture and/or full-bodied mouthfeel and meet nutritional physiological requirements. In particular, a method is provided for the production of a food that is altered with respect to its sensory, technofunctional and/or nutritional physiological characteristics, the method comprising providing an oil-in-water (O/W) emulsion that is produced essentially as described in the above and contains, as related to the total weight of the emulsion, the following components:
(i) 0.2 to 10.0% by weight of protein;
(ii) 0.3 to 10.0% by weight of polar polysaccharide;
(iii) 0.1 to 60.0% by weight of a fat/oil component;
(iv) 0 to 30.0% by weight of a flavoring oil component;
(v) 0 to 30.0% by weight of a polyol;
(vi) 0 to 1.0% by weight of a flavoring agent;
(vii) 0 to 1.0% by weight of an acid; wherein preferably
(viii) the particle size of the dispersed oil or fat drops in maximum dispersion is x_{50.3}≦10 μm (volume-related median value); and/or
(ix) the dry mass of the emulsion is between 5 and 60% by weight; and

further comprising mixing the emulsion with a basic food material for producing a food, wherein the emulsion is present at a ratio of 0.1 to 75% by weight, as related to the basic food product. Preferably, the emulsion is present at a ratio of at least 1% by weight, more preferably at least 2.5% by weight, even more preferably at least 5% by weight and in particular preferably at least 10% by weight, as related to the basic food material.

In a further preferred embodiment of the method according to the present invention, the amount of water contained in the liquid or flowable basic food material (including any amount of water present in other ingredients) is in a range between 20 and 95% by weight, more preferably between 30 and 90% by weight.

This aspect of the present invention is based on the surprising observation that a plurality of foods may be altered and produced using an emulsion that essentially consists of only three components, i.e. protein, polar polysaccharide and liquid lipid (oil, liquid fat); see also the products according to the Examples, which could not be produced nowadays with a satisfactory result using the currently conventional oil/fat emulsions and emulsifiers and the like due to flocculation of the dispersed lipid phase, phase instability or water separation. This object of the present invention is mainly described with reference to the use of an emulsion containing pectin (PE), sodium carboxymethylcellulose (CMC) and sodium alginate (Alg) as polysaccharide component and whey protein (WPI) and lupine protein (Lup) as protein component. Unless otherwise indicated, the embodiments described for this purpose equally comprise embodiments in which the employed emulsion contains alternative or equivalent polysaccharide and protein components. It is further understood that an embodiment of the present invention as described herein or the characteristics thereof may also be combined with one or more further embodiments and characteristics thereof as described herein, unless the respective embodiments mutually exclude one another.

The basic food material, into which the emulsion is mixed according to the present invention, normally has an essentially neutral or preferably acidic pH value. Optionally, the pH value may be further reduced in another step, either during or after adding the emulsion to the basic food material or after obtaining the respective food product.

The foods may be produced according to any suitable conventional technique, depending on the respective type of food composition. Such techniques are well known to the person skilled in the art and do not require further elaboration herein; they may, however, include mixing, blending, extrusion homogenization, high-pressure homogenization, emulsification or dispersion. The foods may be subjected to a heat treatment step, for example pasteurization or UHT treatment. Finally, in a further embodiment of the method according to the present invention, the food obtained may be packaged in a suitable container and/or stored under suitable conditions. In a further embodiment of the method according to the present invention, obtaining the food product is followed by a further step in which the food is preserved according to conventional methods.

The present invention further relates to the foods obtained by the method according to the present invention, for example selected from milk or dairy products, puddings, smoothies, confectionery, specialty food products, soups, sauces, marinades, infant formulas, ice cream products, meat products, baked goods, sponge cake creams or dough, and in particular the foods and food classes listed in the tables of FIGS. 4 to 7. In a particularly preferred embodiment of the food according to the present invention, said food is an instant product; see also the tables in FIGS. 4 to 7. The foods obtained according to the present invention may be distinguished from conventional food products or from the basic food material employed, besides the detection of PPS, preferably with respect to the creamy and full-bodied mouthfeel and/or by an increasedly homogeneous consistency.

Due to experiments on the production of milk products, which were conducted in the context of the present invention, it was furthermore surprisingly found that the use of PPS facilitates the production of food substitutes having a dry mass that essentially consists of PPS. In particular, this applies to dietetic food substitutes, as one preferred embodiment employs PPS that is produced using polysaccharides that have an energy content of essentially 0% and a fiber content between 70% and 80%. Thus, the present invention also particularly relates to methods for producing low-calorie foods and foods having a reduced calorie content as compared to conventional products, in particular dietetic food products and beverages such as “near water” beverages, fruit shakes and “Sgroppino”, and in particular milk beverages such as “healthy milk” and “lactose-free milk”.

Furthermore, the present invention relates to food products that have improved physical and sensory characteristics and are suitable for the use as meal replacement products,for example as described in the international patent application WO2005/023017, the disclosure content of which is hereby incorporated by reference in the present application. Accordingly, the present invention also relates to food compositions as described in document WO2005/023017, wherein, according to the present invention, PPS is contained in addition or as an alternative to, for example, the otherwise employed gelatine, as is indicated in the tables of FIGS. 4 to 7 for individual food classes. As described in Examples 4 and 5, food products may also be produced or altered in terms of quality by the addition of PPS in accordance with the present invention. Herein, the type of PPS employed may form the essential basis for specific food products. Accordingly, calorie-controlled products that have an adjusted energy density and maintain their sensory characteristics even upon prolonged periods of storage may also be produced. Thus, the present invention also relates to foods that may be produced according to the method of the present invention and have a dry mass that essentially consists of PPS. Typically, the dry mass of PPS constitutes >50% by weight, preferably >75% by weight, particularly preferably 90% by weight or optionally up to 95% by weight of the respective food. In one embodiment, the present invention relates to a food composition comprising a skimmed milk with 5 to 10% by weight of PPS20 and optionally a flavoring agent, a polyol and/or an essential fatty acid.

In one embodiment of the food composition that is essentially based on PPS, said food composition preferably comprises added vitamins, selected from at least one of vitamin A, the vitamin B complex (vitamin B₁, vitamin B₂, pantothenic acid, vitamin B₆, biotin, p-aminobenzoic acid, choline, inositol, folic acid, vitamin B₁₂), L-ascorbic acid (vitamin C), vitamin D, vitamin E and vitamin K. In a further embodiment, added minerals are preferably contained, selected from at least one of calcium, magnesium, potassium, zinc, iron, cobalt, nickel, copper, iodine, manganese, molybdenum, phosphor, selenium and chrome. The vitamins and/or minerals may be added by using vitamin premixes, mineral premixes and mixtures thereof or may alternatively be added individually. The vitamins and minerals in the composition must be provided in a format that will enable them to be reabsorbed by the consumer and must therefore have a good bioavailability.

In the sector of healthcare products, the compositions according to the present invention are useful as carriers or vehicles in formulations of pharmaceutical, cosmetic and personal hygiene products. Examples for such formulations are, without limitation, hand and body lotions and creams, bath oils, shampoos and conditioners, sunscreen lotions, lipsticks, eye shadow, talcum powder, foot powder, medicinal oils, vitamins, antibiotics, fungicides and the like. For producing a skin cream or salve, for example 50% by weight of PPS20 are used as a basic substance to which ingredients are then added that are otherwise conventional for creams and salves in the art. In particular, PPS as a pharmaceutical or cosmetic composition may contain the following ingredients, either individually or in any combination: hydrophilically modified silicones; plant extracts; amino acids, peptides, proteins and derivatives thereof; oligonucleotides; further polymers; vitamins; flavonoids; isoflavonoids; ubiquinone compounds; UV-screening substances; serum-regulating agents; antiperspirants; antioxidants. For concrete examples of the above-mentioned ingredients as well as further active ingredients, excipients and additives see, for example, the German patent application DE 10 2006 031 500 A1, the disclosure content of which is hereby incorporated by reference in the present description.

In the field of seed coating techniques, said compositions are similarly useful as carriers for fungicides, herbicides, nematicides, growth regulating agents, hormones, fertilizers, germination stimulators and other active ingredients, as is known in the prior art.

In the food industry sector, PPS is useful as a dispersing or emulsifying agent for emulsifying further oils or volatile agents, flavoring agents, aromatic agents, extracts from fresh fruit and the like. PPS may also be employed in the agricultural sector, for example as a coating for fruit and vegetables in order to delay spoilage or for inhibiting oxidation, and could also be used for protecting buds and bulbs. Furthermore, PPS may be contemplated for the production of fertilizers.

Industrial applications of PPS include the formulation of coating agents, adhesives, window putty, paint thickeners, inks, polishes, tinctures, paint removers, detergents, lubricants, toners and drilling sludges, binding agents in concrete and sealing materials and fillers in synthetic formulations having an improved compatibility with hydrophobic additives and synthetic materials.

In this context, the surprisingly high water binding capacity of PPS is also advantageous concerning its use in the building material sector, for example as a water retention agent and setting retarder. Thus, the present invention also relates to PPS-based dry building material mixtures and the use thereof. In the prior art, for instance, dry building material mixtures based on calcium sulfate are known; see for example the German patent application DE 10 2007 027 477 A1, the disclosure content of which is hereby incorporated by reference in the present description. According to the present invention, PPS may be used in such dry building material mixtures, for example to partially replace calcium sulfate and/or to contribute to the water retention capacity. The dry building material mixture according to the present invention can, for example, be used as a joint filler for plasterboard, but also as putty or plaster. In one embodiment, PPS is contained as a setting retarder in a dry building material mixture at 0.01 to 2.0% by weight. In respect to further potential ingredients of the dry building material mixture see the German patent application DE 10 2007 027 477 A1.

In a further embodiment of the present invention, PPS is employed in a detergent, for example in the form of a tablet, powder, granulate, liquid, gel or in individual doses. In one embodiment, PPS will be employed by selecting corresponding oils as the skin care compound of a detergent dose, as is, for instance, described in the German patent application DE 10 2006 029 837 A1, the disclosure content of which is hereby incorporated by reference in the present description. In this case, PPS can be employed as a system component for regulating the solubility of the detergent substances, as is described in document DE 10 2006 029 837 A1. Further detergent, cleaning compound and care product doses that consist of an external resting form and contain one or more fillings are basically known to the person skilled in the art; see also the German patent application DE 102 44 802 A1, the disclosure content of which is hereby incorporated by reference in the present description. The ingredients conventionally used for detergents, cleaning compounds and care products may also be taken from the indicated prior art.

Formulations of PPS may be produced by any suitable conventional technique according to the type of the composition. Such techniques are well known to the persons skilled in the art and do not require further elaboration herein, they may, however, include mixing, blending, extrusion homogenization, high-pressure homogenization, emulsification, dispersion or extrusion. Foods may be subjected to a heat treatment step, for example pasteurization or UHT treatment. Finally, in a further embodiment according to the present invention, PPS or the formulation obtained using PPS can be packaged in a suitable container and/or stored under suitable conditions.

In light of the above and the subsequent Examples it is furthermore obvious that the present invention also generally relates to the use of PPS as a food additive and/or preferably for adjusting desired sensory characteristics of a food product.

In the following, the invention will be described in more detail by reference to a preferred embodiment without, however, limiting the subject matter of the present invention.

### EXAMPLES

Materials

Proteins

Sodium caseinate DSE 7894, NZMP, NZ/Fonterra (Europe) GmbH, Germany

Milk protein concentrate DSE 9148, dito

Whey protein isolate DSE 5669, dito

Whey protein concentrate NuDr 8080, partially denatured, Arla Foods amba, Denmark

Organic whey protein concentrate P 50, BMI eG, Germany

NZMP 7080, 315410 (moderately hydrolyzed) NZ/Fonterra (Europe) GmbH, Germany

Alatal 821, 315409 (strongly hydrolyzed) NZ/Fonterra (Europe) GmbH, Germany

Peptigen IF-3080 (strongly hydrolyzed) Arla Foods Ingredients, Denmark

Organic skimmed milk powder, HEIRLER CENOVIS GmbH, Germany

Pea protein PISANE M9, Cosucra Group, B/Georg Breuer GmbH, Germany

Soy protein SOYPRO-900 IP, Kerry Group, Ireland/Georg Breuer GmbH, Germany

Lupine protein LUPIDOR HP, HOCHDORF Nutrifood, CH/Georg Breuer GmbH, Germany

Potato protein EMVITAL K5, Emsland Group, D/Emsland-Starke GmbH, Germany

Polysaccharides

High-esterified pectin Herbacel Classic CU 201 (Pektin HV), Herbstreith & Fox, Germany

High-esterified pectin Herbacel Classic AS 501 (Pektin HV), Herbstreith & Fox, Germany

Herbapekt SF 06-A-APE (˜25% pectin content), Herbafood Ingredients GmbH, Germany

Low-esterified pectin OP0301 (NVP), OBIPEKTIN, Switzerland

Amidated low-esterified pectin OPO404 (ANVP), OBIPEKTIN, Switzerland

Amidated low-esterified pectin GRINDSTED LA 415 (Pektin NV), Danisco A/S, Denmark

Gummi arabicum (GA): spray-dried, Ph. Eur., ROTH GmbH & Co. KG, Germany

Alginates FD 120, GRINDSTED, Danisco A/S, Denmark

Carrageenan Cerogel, Type CL-07-Lambda, C.E. Roeper GmbH, Germany

Amylopektin C*Gel 04201 Waxy maize starch, Cargill Deutschland GmbH, Germany

Sodium carboxymethylcellulose WALOCEL CRT 1.000 GA (Na-CMC), Dow Wolff Cellulosics, Germany

Oils

Neutral oil Miglyol® 812 (MCT), density 0.9400 g/cm³, Sasol Germany GmbH, Germany

Neutral oil Miglyol® 829, density 1.010 g/cm³, Sasol Germany GmbH, Germany

Rapeseed oil Rapso, density 0.920 g/cm³, VOG AG, Austria

Sunflower oil Sonnin, density 0.921 g/cm³, Walter Rau Lebensmittelwerke, Germany

Herb oil concentrate K-Öl; TH, Thyme; PF, Peppermint; AN, Aniseed; Camomile, Oregano, density 0.9210 g/cm³, EG Ölmühle & Naturprodukte GmbH, Kroppenstedt, Germany

Miscellaneous

Deionized water (electrical conductivity: <2 μS/cm) or tap water of low hardness

SAIB, Sucrose diacetate hexaisobutyrate (SAIB-SG), Aldrich W51.810-7-K, density 1.1460 g/cm³, Sigma-Aldrich, Germany

Methods

Method for Measuring the Size Distribution of Oil Drops

The desired size distribution of oil drops is an essential parameter in the preparation of the emulsion. Particle size analysis was performed with the measuring device Coulter Electronics LS 100 (laser diffraction system, measuring range 0.4 to 900 μm, wave length 750 nm) using the MVM module. The distribution of the particles of the O/W emulsions was measured in distilled water with and without the addition of SDS (sodium dodecyl sulfate). In case a tighter particle size distribution with a smaller mean particle size is measured subsequently to the addition of SDS, it may be assumed that drop aggregates are present in the emulsion examined (protein-stabilized emulsions that are not produced according to the present invention generally exhibit drop aggregation upon the addition of acid; this also applies to emulsions containing heat-denatured whey protein).

The volume-related mean diameter d₄₃, the surface-related mean diameter d₃₂, the modal value (the value most often occurring within a series of measurements) and the SPAN (factor for the distribution width, SPAN=(d₉₀%−d₁₀%)/d₅₀%) were taken into account in the evaluation. As in many cases different parameters are indicated for the particle size, the volume-related median value x₅₀ is preferably used herein. This value indicates that 50% of the drop volume are captured by drops that are smaller than the given drop diameter x₅₀. In order to relate the indication to the volume-related median value, the further indication x_{50.3} is given.

Creaming and Phase Stability

In order to examine the stability of the O/W emulsions differing with respect to their mode of preparation and composition, 10 ml each of said emulsions were filled into a graduated centrifuge tube. After 60 and 120 min (and after longer periods of time, respectively) the separated serum of the creamed emulsion or the oil phase were evaluated. Furthermore, the phase alteration with respect to phase separation was observed in a time-dependent manner (up to 14 days of storage at +16° C.).

Microscopic Examination

Examining the microscopic appearance of the emulsions was performed using the microscope BX61 (OLYMPUS Deutschland GmbH, Hamburg), equipped with a Color View camera (Soft Imaging System) and the image analysis software analySIS® (Soft Imaging System). Prior to the visual examination, the emulsions were diluted with deionized water in a ratio of 1:10. One drop of each sample was applied onto a diagnostic slide (ROTH GmbH & Co. KG) and evaluated for single drop distribution or drop aggregation at 200-fold magnification. In these examinations no oil separation was observed.

Rheological Characteristics

Characterizing the rheology of the emulsions was performed using a cone/plate measuring system (Rheostress RS 300, THERMO HAAKE, Karlsruhe). A cone with a diamter of 60 mm and an angle of 1° was employed. The measuring temperature was 23° C. About 1 ml of the sample was applied onto the plate and tempered for 3 min (Thermostat DC30, HAAKE). The shear rate was continuously increased from 0 to 100 s⁻¹. According to the rheological law of OSTWALD-DE WAELE, the consistency factor k was determined on the basis of the measured values.

τ=k·γⁿ

τ shear stress (Pa)

k consistency factor (Pa sⁿ)

n flow exponent

γ shear rate (s⁻¹)

Determining the Freeze/Thaw Stability

Highly viscous stable emulsions were stored at −17° C. (for at least 24 hours) in form of a thin layer (2 mm) between PE film (film bag), subsequently stored at +20° C. for 1 hour. Thin, stable emulsions (phase-stable for at least 24 hours) were filled into 5 ml cryotubes and stored at −17° C. for at least 24 hours, subsequently stored at +20° C. for 1 hour. The appearance (degree of stability of the emulsion) of the emulsion was evaluated. Separated emulsions (no smooth appearance, separation of water) were classified as freeze/thaw-unstable. A separation of oil (and “oil leaking” of the emulsion, respectively) was not observed in these experiments.

Visual Observation

Particular abnormalities in the production of the protein solutions, in the mixing of the solutions, in the production of the emulsions as well as during the storage of the emulsions were registered.

Measuring the pH Values of the Emulsions

The pH values of the freshly prepared emulsions were measured without dilution using a single-rod electrode HI 1131 (pH meter, Hanna Instruments).

Turbidity Characteristics of the Emulsions upon Dilution

0.05 ml of emulsion are diluted in 7 ml of deionized water and the degree of turbidity is subjectively evaluated and photo-documented. The same steps were also performed after the addition of 0.1 ml of 10% citric acid to 7 ml of diluted emulsion solution.

Mixing the Emulsion with Aronia Juice

At a ratio of 2:1 (emulsion:juice), the neutral emulsions were mixed with wild fruit juice (aronia juice, pH 2.9, Kelterei Walter GmbH u. Co KG, 01477 Arnsdorf) and characterized with respect to phase stability and mouthfeel (consistency).

### GENERAL DESCRIPTION OF THE METHOD ACCORDING TO THE PRESENT INVNETION

Protein and polysaccharide and, optionally, a polyol, in the amounts as indicated in the previous Tables 1 and 2, are separately dissolved in water using a stirring device at 50° C. and 70° C., respectively, and are subsequently mixed (aqueous phase), wherein the aqueous phase is preferably produced by mixing a solution containing the protein into a solution containing the polysaccharide; also see FIGS. 1 and 3. With the use of neutral amylopectin instead of charged pectin or CMC, the former is preferably used at a concentration of about 2.15% (content in the emulsion) and is heated to 90° C. until a light and highly viscous solution is obtained. In solubility preliminary test it was determined at what polysaccharide contents the aqueous phases still maintain suitable flow characteristics for preparing the solutions, i.e. are still flowable. Preferably, whey protein isolate (WPI) (DSE 5669, Fonterra GmbH, Germany) is employed as protein and high-esterified pectin (P-HV) (Classic AS 501, VE 57%, Herbstreith & Fox GmbH, Germany) is employed as polysaccharide. Prior to use, it may be recommendable to filter the P solution under sterile conditions, for example using a 0.2 μm ceramic membrane at 4 MPa.

The oil or fat component and, optionally, a flavoring oil component are heated to about 50° C. or until all the fat has melted at 60° C. (oil phase). Sunflower oil or rapeseed oil and optionally herb oil or fruit pulp oil as a flavoring oil component are preferably used as oil component. Preferably, the polysaccharide solution is pasteurized by heating to 95° C. (for 10 min) prior to use.

The oil phase is then dispersed in the aqueous phase, for example using a star stirrer at 1,500 rpm and at a temperature of less than 60° C., preferably at 40 to 45° C., also preferably at about 30° C., and is post-emulsified using a rotor/stator emulsifying device (e.g. CAT-X620, M. Zipperer GmbH, Staufen) at 20,500 rpm for about 1 minute to obtain a median particle size in a range of preferably x₅₀<10 μm, preferably <1.5 μm and particularly preferably <1.2 μm. If required, fine-emulsification is carried out using a high-pressure emulsifying device, such as the EmulsiFlex C5 (20 to 50 MPa, AVESTIN, Canada) or another pressure homogenizer, in order to obtain the desired particle size.

If, for instance, PPS is to be employed at a high dilution, an especially small particle size (preferably <1 μm) is advantageous. For the addition to a highly viscous basic food material, a mean particle size of about 5 μm will be sufficient.

The requirements made on the emulsifying device are determined by the required particle size and the viscosity of the emulsion. For low-viscosity emulsions, ranges of particle size of x_{50.3}=1.0 μm may easily be obtained from a pre-emulsion using conventional high-pressure emulsifying devices, whereas the same is only possible for high-viscosity emulsions using specifically designed high-pressure emulsifying devices or specifically designed processing plants (e.g. equipped with a suitable rotor/stator system).

For instance, using the vacuum processing plant MaxxD 200 (FrymaKoruma), which operates based on the principle of gear rim dispersion (gear rim rotor and stator), and selecting suitable gear rim tools, a high-viscosity emulsion PPS 20 CMS may be produced that has a particle size of x₅₀=1.2 to 2.5 μm. This particle size is sufficient for employing the emulsion to obtain high-viscosity products, in particular if the aim of manipulation of consistency is desired.

Using a high-pressure homogenizer, such as EmulsiFlex C5, a particle size with x₅₀ being between 1.1 and 1.3 μm is obtained. To this end, however, the preparation of a pre-emulsion is required (gear rim dispersing device or stirrer with high energy input). Such emulsions, which were employed for flavoring at high dilutions, additionally had a high creaming stability as a weighting agent had been added to the oil in order to increase its density.

The pH values of the emulsions obtained that contain polysaccharides and proteins and have a neutral pH value are within a range of about pH 7.0. If, however, a polysaccharide having an acidic pH value is employed (e.g. high-esterified pectin), the pH value of the emulsion obtained may range from about pH 4.4 to 4.8. The pH value of the neutral emulsion and also of the emulsion in the acidic pH rage may be lowered, for example by adding a 10% acid such as citric acid. The addition of an acid is preferably omitted, however. In the following Examples, PPS produced without the addition of an acid is employed.

Finally, a pasteurizing step, preferably at about 85° C., particularly preferably a heat treatment at about 75° C., may also be conducted. After cooling, the emulsion is preferably filled into sterile containers at about 60° C.

Use of the Emulsion PPS in the Production of Various Products

For a representative selection of products, see Examples 3ff, relevant product data and information was systematically ascertained, the product was sensorially characterized in its original state and then once more subsequently to the addition of x% (by weight) PPS20, unless otherwise indicated. The value x varies according to the respective product sector. The PPS type, i.e. for example PPS-CMC or PPS-PE, may be taken from Tables 1 and 2, including the respective exact compositions, unless otherwise indicated. The selected values are median values and may vary individually. PPS with x% DM (dry mass) was added as additional component or mixing component for mixed products, wherein mixing was performed in no specific order. Optionally, the end product was intensively mixed with PPS using a suitable rotor/stator system for obtaining an even particle distribution.

To determine the amount or concentration of PPS that is sufficient for texturing a selected food, 10%, 20% and 30% of PPS20 were admixed as additional component or mixing component of the following products, unless otherwise indicated. Water separation and, in case of foods, mouthfeel prior and subsequently to the addition of PPS20 of the products were examined and tasted by at least three persons.

Detection of PPS and of PPS Contained in Mixed Products

In principle, PPS essentially consists of a protein, a polar polysaccharide and an oil or fat and is, inter alia, characterized in that (a) flocculation of the oil drops is avoided, (b) there is no protein/polysaccharide incompatibility, (c) no insoluble protein/polysaccharide complexes with low water binding capacity are formed, and (d) the oil drops in the protein/poly-saccharide phase remain evenly distributed. One possible method for the detection of PPS is reducing the pH value of a diluted or undiluted neutral emulsion or diluting an acid-containing emulsion and performing a zeta potential measurement. With the use of PPS, no spontaneous flocculation occurs upon the addition of acid. In case an acid-containing and stable emulsion is diluted, it may be microscopically examined whether a single-drop distribution is present, which is characteristic for PPS. Furthermore, PPS may contains proteins that usually precipitate upon pH reduction (e.g. casein, vegetable protein). PPS containing whey protein remains relatively phase-stable in the acidic pH range even upon heating (more than 70° C.) if further neutral hydrocolloids are present, which increase the viscosity and stability of the emulsion. In this case it is thus required to perform such a stability test subsequently to the dilution of PPS.

With PPS that is obtainable according to the production methods of variants B and C, see FIGS. 1 and 3, i.e. in which the oil phase is enriched with a polysaccharide (preferably non-standardized pectin) prior to emulsification, a part of the polysaccharide remains in the oil phase and contributes to an increased density of the oil phase. Accordingly, the oil phase of PPS, after dilution of PPS and separation of the oil phase by centrifugation (optionally with the addition of proteases or SDS), has an increased density (e.g. >0.92 g/cm³) as compared to the oil phase of a conventional emulsion of PPS obtainable according to variant A. Once isolated, the polysaccharides in the oil phase may be analyzed using chromatographic or spectroscopic methods.

Products produced with PPS according to variants B and C may additionally have a high oil and polysaccharide content, in particular pectin content. In products having a high dry mass content, a pectin content of more than 2 to 3% in the aqueous food phase is difficult to implement via the addition in form of an aqueous solution. The use of PPS, in particular in variants B and C, thus facilitates an increased pectin content.

### Example 1

### Example of Providing a PPS Emulsion According to Variant A

Preparation of the Emulsion

Whey and lupine protein as well as the polysaccharides were separately dissolved using the stirring device RW 16 equipped with a star stirrer, subsequently the individual protein and polysaccharide solutions were mixed at different ratios (by variation of the protein and polysaccharide concentrations employed and by variation of the protein/polysaccharide ratios). Whey and lupine protein as well as alginate and carrageenan were dissolved while stirring at 50° C., the dispersed amylopectin was heated to 90° C. until a light and highly viscous solution was obtained. In solubility experiments it was determined at what polysaccharide contents the aqueous phases still maintain suitable flow characteristics, i.e. are still flowable.

As illustrated in FIG. 2A, rapeseed oil was dispersed in 95 ml of protein/polysaccharide solution using a star stirrer (stirring device RW 16 basic, IKA Labortechnik, 1,500 rpm; slow addition via a 5 ml pipette), post-emulsified for 30 sec and subsequently post-emulsified for 15 sec using a rotor/stator dispersion rod CAT X 620 (M. Zipperer GmbH, Staufen) at 24,000 rpm. The pre-emulsion thus obtained was finely emulsified at 8 MPa using a laboratory pressure homogenizer (HH 20, equipped with spherical valve, DE 195 30 247 A1). Samples were prepared under germ-reduced conditions. All containers and devices were additionally treated with the alcohol-containing disinfectant “Softasept N” (B. Braun Melsungen). Deionized water was used for preparing the solutions. Accordingly, PPS20 was produced as illustrated in FIG. 2B.

FIG. 2C illustrates the production of PPS24 by the use of whey protein hydrolysates and apple pectin extract, wherein the polysaccharide preparations may be mixed with 4% sucrose to facilitate blending (to avoid clumping upon addition to the aqueous solution). In this embodiment, preferably 2 to 4% NZMP 7080 and 3% pectin or sodium CMC are used, whereas Alatal 821 is preferably combined with pectin. With the use of Herbapekt, 6 or 9% of Herbapekt are added to achieve an increased pectin content (3% pectin in PPS24). As, according to experience, the content of higher-molecular fractions (MW 5 to 10 kDa), which may interact with the pectin, is lower than 35% in the hydrolyzed products, the protein content is increased from 2% to 4 or 6% as compared to the composition of PPS24 (3% pectin or sodium CMC, 2% protein, 4% sugar, 15% oil). The preparation of the solutions and emulsions may be taken from the schematic representation in FIG. 2C. The aqueous phase preferably consists of potable water (16.5 to 19 degrees of German hardness). Further preferred PPS variants are, for instance, PPS12 for the use in milk and milk replacements, wherein 3% of sodium CMC, 4% of organic P 50 protein and 16.50% of cream with 30% fat content (corresponding to about 5% fat content) are used, as well as PPS20 or 22 containing 4% of protein, 3% of sodium CMC, 15% of oil for the preparation of curd cheese desserts; also see FIG. 2D illustrating an embodiment for the preparation thereof. Further standard PPS variants (each with water ad 100%) are:

PPS17.5 containing 1.5% of sodium CMC, 1% whey protein and 15% sunflower oil

PPS20 containing 3% of sodium CMC, 2% whey protein, 15% vegetable oil

PPS24 containing 2.6% of pectin AS 501, 2.65% g whey protein, 18.5% sunflower oil

PPS25 containing 2.6% of pectin, 3.63% whey protein, 18.75% vegetable oil

PPS Variants Having an Especially High Heat Stability

As already explained in the above, PPS may be subjected to a thermic treatment, preferably for 5 sec at 75° C. Basically, reducing the content of protein such as whey protein isolate results in an improved heat stability (prevention of coagulate formation at 85° C.) in more concentrated PPS variants such as PPS25 with pectin and PPS20 with sodium CMC. In previous orientational examinations it was shown that the PPS compositions listed in Table 3 have an especially high heat stability (for 60 min up to 90° C.). The preparation of such products is illustrated, inter alia, in FIG. 2E.

TABLE 3
Preferred composition of heat-stable PPS products

| PPS | | Vegetable | | | |
|---|---|---|---|---|---|
| variant | Milk fat | oil | Protein | Na CMC | HE pectin |
| PPS20 | 5 | — | 2.00 | 3.0 | — |
| | | | (Bio) | | |
| PPS17.5 | — | 15 | 1.00 | 1.5 | — |
| PPS24 | — | 18 | 2.65 | — | 2.6 |
| PPS43 | — | 40 | 1.30 | — | 1.3 |

PPS products having an especially high heat stability are of particular significance if they are to be heat-preserved or if they are to be used as foods (yoghurt, sauces, dressings, creams etc.).

Determining the Freeze/Thaw Stability

The highly viscous and stable emulsions were filled into PE bags, stored at −17° C. for at least 24 hours and subsequently stored at +20° C. for 1 hour. In addition, the stable and low-viscosity emulsions (if stable for at least 24 hours) were filled into 5 ml cryotubes, stored at −17° C. for at least 24 hours and subsequently stored at +20° C. for 1 hour. The appearance (degree of stability of the emulsion) of the emulsion was evaluated. Separated emulsions (no smooth appearance, separation of water) were classified as freeze/thaw-unstable. A separation of oil (“oil leaking” of the emulsions) was not observed in these experiments. The emulsions according to Tables 1 and 2 as well as the compositions indicated in FIG. 2 proved to be freeze/thaw-stable.

Phase Stability of the Emulsion

The emulsions were filled into 10 ml centrifuge tubes and stored at +16° C. During the storage process, the phase stability was observed (e.g. phase separation, separation of water). A separation of oil was not observed in these experiments. The emulsions according to the compositions as listed in Tables 1 and 2 as well as in FIG. 2 were shown to be phase-stable. Phase stability was also achieved in the emulsions containing the polysaccharide sodium alginate in the absence of Ca ions (use of 1.5% by weight of alginate and 1.5% by weight of whey protein). Furthermore, phase stability is provided with the replacement of whey protein for pea, soy and lupine protein (in combination with sodium CMC and high-esterified pectin). If, however, the polar polysaccharide is replaced with neutral amylopectin, no additional texturing effect is observed. The emulsions containing vegetable protein in combination with amylopectin are not stable upon the addition of acid. With a combination of lambda carrageenan containing sulfate groups and whey or vegetable protein, a slight improvement of stability is observed as compared to the emulsions containing amylopectin, but the stability is still lower than when preparing the emulsions with combinations of charged polysaccharides containing carboxyl groups and proteins.

### Example 2

### Preparation of a PPS Emulsion According to Variant B of the Method According to the Present Invention and Use Thereof in the Production of an Organic Beverage

For the production of beverages, in particular organic beverages, the emulsion is preferably prepared according to variant B, as indicated in the schematic representation of FIGS. 1 and 3, namely by mixing the oil phase and the polysaccharide while stirring and subsequently dispersing the resulting mixture into an aqueous phase that contains the protein using a high-pressure emulsifier, for example as described in the German patent application DE 10 2007 057 258.3 “Öl-in-Wasser-Emulsion für Bio-Lebensmittel sowie deren Herstellung und Verwendung”, filed on Nov. 27, 2007, the disclosure content of which, in particular of the Examples, is hereby incorporated by reference in the description of the present application.

Example 2 of document DE 10 2007 057 258.3 for the production of an emulsion of the oil-in-water type (O/W, 20/80) containing a mixture of thyme, oil concentrate and pectin and for the production of an organic beverage is essentially described here for illustrative purposes.

An oil-in-water emulsion (20/80) is prepared using 200 parts by weight of thyme oil concentrate (density 0.921 g/cm³, E. G. Ölmühle & Naturprodukte GmbH/Kroppenstedt, prepared according to document DE 102 01 638 C2 from gently dried organic thyme, Dr. Junghanns GmbH/GroB Schierstedt, and peeled organic sunflower seeds, agaSaat/Neukirchen-Vluyn) and 800 parts by weight of a protein solution, wherein 100 parts by weight of high-esterified pectin (Classic AS 501, VE 57%, Herbstreith & Fox/Neuenbürg) are stirred into and dispersed in the oil using a stirrer equipped with a dispersing gear rim at 1,300 rpm for about 15 min. In the dispersion procedure, the oil obtains a turbid and highly viscous consistency (density about 1.020 g/cm³). For preparing the aqueous phase of the emulsion, 20 parts by weight of organic whey protein (Bio-P50, about 60% protein content, BMI/Landshut) are dissolved in 780 parts by weight of water and employed for preparing the oil-in-water emulsion (20/80). Using a rotor/stator dispersing device (CAT-X620, M. Zipperer GmbH/Staufen) at 20,500 rpm, 200 parts by weight of a mixture of thyme oil concentrate and pectin are stirred into 800 parts by weight of said aqueous phase, followed by 1 min of subsequent emulsification. Fine-dispersing of the emulsion is then performed using the high-pressure emulsifier EmulsiFlex C5 (AVESTIN/Canada) at 50 MPa. The mean drop size d₃₂ of the oil drops in the emulsion is 0.91 μm.

For preparing the organic beverage, 50 parts by weight of organic agave syrup (Alfred L. Wolff Honey GmbH/Hamburg) are dissolved in 935 parts by weight of water (density about 1.014 g/cm³) and the resulting solution is mixed into 9 parts by weight of the emulsion (O/W, 20/80) with pectin-containing thyme oil concentrate and is dispersed. Subsequently, the pH value is reduced to about 2.9 by adding 6 parts by weight of 50% hibiscus extract solution (Plantextrakt/Vestenbergsgreuth). The highly turbid beverage thus obtained is filled into suitable bottles and impregnated with CO₂ gas.

The highly turbid beverage has a pleasant and refreshing taste of thyme and is agreeable with respect to acidity and sweetness. After a 4-week period of storage at +8° C., the high turbidity is still present, sediment is present neither at the surface nor the bottom and the beverage is phase-stable.

Instead of apple pectin with VE 57%, finely powdered citrus pectin CM 201 (VE 68 to 76%) and/or instead of thyme oil concentrate, a peppermint leaf oil concentrate prepared from organic peppermint leaves according to document DE 102 01 638 C2 may also be used. Furthermore, 5% by weight of wheat syrup Sipa-Wheat F28 (Sipal Partners S.A/Belgium) may be used as a sweetening agent instead of agave syrup. In another example, organic sea buckthorn pulp oil (Sanddorn GbR, KbA, Germany) is used as a flavoring agent instead of herb oil concentrate and after mixing with high-esterified citrus pectin CM 201 at 20° C. an O/W emulsion 20/80 is prepared. For dispersing the emulsion, the beverage solution may optionally contain 200 parts by weight of aloe vera organic plant juice (Anton Hubner GmbH/Ehrenkirchen) in 1,000 parts by weight of beverage.

It is also possible to increase the oil phase volume in the emulsion from 20/80 to 40/60.

### Example 3

### PPS in Cocktail and Mixed Beverage

For this purpose, the emulsion according to the present invention is preferably prepared according to variant A (FIG. 1, also see Example 1) and/or with vegetable protein.

a) Sgroppino consisting of 80 parts by weight of milk (3.5% fat), 2.4 parts by weight of “Citro-Back”, 24 parts by weight of “Kathi” lemon sugar, 480 parts by weight of wine (Mario Muskat), 24 parts by weight of vodka and optionally 16 parts by weight of Hitchcock's pure lemon juice mixed with 192 parts by weight of PPS20-CM.

b) Pina Colada consisting of 140 parts by weight of Pina Colada, 280 parts by weight of exotic juice (Rapp's “Rosige Zeiten”) and 140 parts by weight of Coconut Creme (Maruhn GmbH) mixed with 70 parts by weight of PPS20-CM.

The above beverages a) and b) have a pleasantly creamy taste, develop their typical aroma and are phase- and turbidity-stable even upon prolonged periods of storage.

### Example 4

### Enriching Skimmed Milk with Vegetable Oil

It is envisaged to generate a full-bodied milk that is enriched with vegetable oil from skimmed milk.

Skimmed milk with a fat content of 0.1% was employed. Milk with a fat content of 3.8% served for comparative purposes. Whereas the skimmed milk without the addition of PPS tastes stale, thin and flat, has no body and produces a watery mouthfeel, the addition of 5% by weight of PPS20-CM produces a distinctly creamier mouthfeel. With an increase of the addition to 7.5% by weight of PPS20-CM, the mouthfeel of the enriched skimmed milk (about 1.1% by weight of vegetable oil) is comparable with respect to full-bodiedness to that of whole milk having a fat content of 3.8%.

### Example 5

### Milk Having an Increased Content of Polyunsaturated Fatty Acids

It is envisaged to generate a sensorially pleasing milk from skimmed milk, having additional advantages such as probiotic characteristics and an increased content of polyunsaturated fatty acids.

### 5.1 Enrichment with Olive Oil and Addition of PPS20-CM

It was tested whether an additional enrichment of skimmed milk with olive oil in the simultaneously presence of PPS was possible. 4.5 parts by weight of PPS20-CM and 9.5 parts by weight of olive oil (corresponding to 0.7% by weight of sunflower oil from PPS20 and 10% by weight of olive oil in the milk) were added to 86 parts by weight of skimmed milk (0.1% fat content). As compared to whole milk (3.8% fat content), the homogenized milk had a slightly creamy consistency and tasted full-bodied, creamy, slightly nutty and a bit like vegetable oil. The mouthfeel was absolutely round and full-bodied, creamy and not too viscous. The only disadvantage of milk thus obtained is its fat content of about 10.8%, due to which further examinations were carried out using different PPS contents while reducing the addition of oil.

### 5.2 Direct Enrichment of Milk with Omega-3 Fatty Acids

Owing to the positive result of Example 4, skimmed milk (0.1% fat content) containing 5% by weight of PPS20-CM was determined as the basis for further examinations regarding the production of milk having an additional health advantage.

### 5.3 Enrichment of Skimmed Milk with PPS20, Omega-3 Fatty Acid and Inulin

a) For these experiments, omega-3 fatty acid was provided in the form of a powder (CPF n-3 concentrate). This preparation had an unpleasant and very oily taste. It was examined whether the combined addition of CPF n-3 concentrate and PPS20 could contribute to masking this taste. 4.73 parts by weight of PPS20-CM and 0.47 parts by weight of CPF n-3 concentrate were added to and mixed with 94.80 parts by weight of skimmed milk. The milk product produced a creamy and full-bodied mouthfeel, but still displayed a somewhat oily taste. Upon reducing the skimmed milk content by 0.56% parts by weight and replacing it with 0.56 parts by weight of inulin, the consistency of the milk remained unaltered. This posed the problem of masking the slightly oily taste by means of additional flavoring (see 5.4).

### 5.4 Flavoring Milk with PPS20, Enriched with Omega-3 Fatty Acids

Vanilla flavor in the form of liquid butter vanilla aroma (BVA) in combination with sucrose was used for flavoring.

It was possible to improve the taste of the skimmed milk that was enriched with PPS20 and omega-3 fatty acids in Example 5.3 by adding 2% by weight of BVA and 3% by weight of sucrose, such that the oily note could no longer be detected in the pleasant and full-bodied taste. The mouthfeel is equal to that of whole milk.

### Example 6

### Improving the Consistency of Yoghurt Using PPS

10, 20 or 30% by weight of PPS20-CM were mixed (hand mixer) into yoghurt having 1.5% fat content. The sensory evaluation revealed that the addition of PPS improves the water binding capacity of the non-smooth, slightly flocculent yoghurt as compared to the original sample and renders the yoghurt significantly creamier with an addition of 10% by weight or more of PPS. According to the sensory evaluation with respect to consistency and taste, the optimal PPS addition is in a range between 10 and 15% by weight.

### Example 7

### Improving the Consistency of Low-Fat Curd Cheese

10 to 30% by weight of PPS20-CM were stirred into curd cheese having 0.2% fat content. In the sensory evaluation, hardly any difference in color was detected. While the low-fat curd cheese exhibits water separation and is slightly fissured, the addition of PPS20 (10% by weight or more) alters its appearance (less fissured, only slightly cracked, yet not smooth) and improves its taste (creamier). With the addition of 10% by weight or more of PPS20, the mouthfeel becomes increasingly creamier and smoother. The optimum is in a range around 15% by weight of PPS20.

### Example 8

### Improving the Consistency of Butter Milk

Buttermilk having a fat content of 1% was enriched with 10 to 30% by weight of PPS20-CM. Whereas the non-enriched buttermilk was characterized as slightly greyish, very thin, watery and slightly uneven in the sensory evaluation of the original sample and the enriched samples, the buttermilk samples showed an increasingly smooth and creamy consistency with increasing PPS content. While the taste of buttermilk is hardly influenced by the addition of PPS, the milk increasingly resembles the appearance of whole milk as the PPS content is increased. The optimum is in a range around 20% by weight of PPS20.

### Example 9

### Influencing the Consistency of Kefir

Kefir having a fat content of 1.5% was mixed with 10 to 30% by weight of PPS20-CM. The original sample is relatively smooth and no separation of water is observed. The addition of 10% by weight of PPS20 produces a distinctly creamier and smoother mouthfeel. The optimum for achieving a pleasant creaminess is in a range between 10 and 20% by weight.

### Example 10

### Refinement of Mayonnaise with PPS

According to variant A of Example 1, PPS20-PE is prepared using whey protein and high-esterified pectin. Basil oil concentrate is used as oil phase. 100 parts by weight of deli mayonnaise (80% fat content) are mixed with 5 parts by weight of PPS20-PE. The deli mayonnaise becomes creamier, has a pleasantly herbal taste and is excellently suited for flavoring salads. Due to its creaminess and improved lubricity it is also suitable for being filled into tubes. The substitution of the herb oil concentrate by further herb oil concentrates (thyme, rosemary, tarragon, wild garlic, cumin etc.) enables a wide variation of mayonnaise flavors that can be adjusted in intensity via the PPS content, without negatively influencing the consistency.

### Example 11

### Influencing the Consistency of Remoulade Sauce

By adding 15 parts by weight of PPS20-CM to mixtures consisting of 160 parts by weight of deli mayonnaise, 75 parts by weight of freshly chopped herbs and 100 parts by weight of whole milk, a mild remoulade sauce can be prepared that produces a pleasantly creamy and soft mouthfeel. Without the addition of PPS, the remoulade sauce does not exhibit the same pleasantly creamy consistency. The consistency of such a remoulade sauce may easily be adjusted in terms of flow characteristics and adhesiveness if instead of the 15 parts by weight of PPS20-CM a PPS20-PE is employed that has been prepared according to variant B or C and has a pectin content (high-esterified pectin) of 3% by weight in the emulsion (see Tab. 1).

### Example 12

### Influencing the Characteristics of Mustard Dressing

A mustard dressing, prepared from 150 parts by weight of olive oil, 75 parts by weight of balsamic vinegar, 50 parts by weight of tarragon mustard, 50 parts by weight of whole milk, 11 parts by weight of table salt, 3 parts by weight of crystal sugar, 3 parts by weight of onion powder and 1 part by weight of black pepper, without the addition of PPS, is spicy in a very one-sided manner and tastes too strongly of vinegar. The addition of 15 parts by weight of PPS20-CM renders the mustard dressing somewhat thicker, milder and creamier with respect to mouthfeel, rounder in taste as well as lighter in appearance.

### Example 13

### Influencing the Characteristics of a Curry Dip

A curry dip, prepared from 250 parts by weight of Crème Fraiche, 250 parts by weight of whipped cream (35% fat content), 20 parts by weight of curry powder (Fuchs Gewürze), 10 parts by weight of table salt and 1 part by weight of garlic powder, has a non-smooth, flocculent appearance after preparation. Its taste is somewhat one-sided, intense and strong. By adding 10 to 15% by weight of PPS20-CM, the product obtains a rounder and softer taste as well as creamier consistency characteristics.

### Example 14

### Refinement of Pesto

Original pesto (with its typical separation of oil) is rendered smoother and lighter by the addition of 10 to 15% by weight of PPS20-CM (stirring with a hand mixer). With 20% by weight and more, no separation of oil is observed. In particular, the addition of PPS20 (up to 20% by weight) reduces oil separation without negatively influencing the strong taste.

### Example 15

### Improving the Consistency and Stability of Italian Tomato Sauce

The phase separation of tomato sauce can be eliminated by admixing PPS20-CM (addition of 10 to 15% by weight, using a hand mixer). The product is rendered smoother and softer with respect to mouthfeel as well as slightly lighter in color.

### Example 16

### Scalded Sausages

The production of meat products like scalded sausages or minced meat is known in principle, see for example the German patent applications DE 199 38 434 A1 and DE 10 2006 026 514 A1, the disclosure content of which is hereby incorporated by reference in the present description. For producing scalded sausages, for example 10 kg beef and 5 kg pork neck fat are used. The meat is cut into cubes, pickled with the conventional amount of pickling salt and stored over night in a cold-storage room. On the following day, the meat is minced using a 2 mm meat grinder disc frozen PPS20-CM (pre-cut) is added and bowl cutting is performed until the desired degree of fineness is obtained. Then, the finely pre-cut pork fat and the spices are added, followed by another bowl cutting step to obtain a mass of the required fineness. The amount of PPS is 250 g per 1 kg meat mass. The sausages thus obtained are characterized by a reduced fat content and produce a pleasant mouthfeel after frying.

### Example 17

### Improving Minced Meat Products

In the production of meat loafs, meat balls, burgers and the like, beef and pork are conventionally used. As in the previous Example, 250 parts by weight of PPS20-CM are added per 1,000 parts by weight of meat mass. The sausage thus obtained is characterized by a reduced fat content and a pleasant mouthfeel.

### Example 18

### Improving the Consistency of Liver Spread

In the production of fine liver spread, which consists of pork, liver and further conventional ingredients (without emulsifiers), 250 parts by weight of PPS20-CM are added per 1,000 parts by weight of pork, as described in Examples 15 and 16. As compared to the liver spread without the addition of PPS20, a creamier liver spread is obtained that exhibits improved spreading characteristics and an even fat distribution and produces a smoother mouthfeel.

### Example 19

### Canned Fish with Sauce (Fried Herring “Home Style” in Spicy Marinade Containing 20% by Weight of PPS)

Tender fried herring, home-style cooked and served in a spicy marinade, consisting of herring, wine/brandy vinegar, vegetable oil, wheat bread crumbs, onions, sugar, tomato paste, iodized table salt, wine, seasoning, flavor and spices, were refined by adding 20% by weight of PPS20-CM. The hot and spicy original product could be improved by PPS, namely with respect to overall mouthfeel (less sour and smoother marinade) and appearance (more appealing).

### Example 20

### Dough- and Baked Goods (Pizza Dough Containing 7.5% by Weight of PPS)

300 g flour, 20 g yeast, ⅛ liter warm water, half a teaspoon of salt and two tablespoon of olive oil are mixed with 7.5% by weight of PPS20 to form a dough. After proving, the dough is covered with tomato pieces and baked in the oven at a conventional temperature. The pizza base is fluffy and has a pleasant taste.

### Example 21

### Improving the Consistency of Fruit Smoothies

Products having a fruit content of 100%, like orange, mango, passion fruit smoothies as well as a smoothie mixture consisting of apple juice (41%), orange juice (16%), mango pulp (15%), banana pulp (14.5%), passion fruit juice (7%), orange pulp (2.5%), apple pieces (2%) and mango pieces (2%), were mixed with 7.5% by weight of PPS20. The enrichment of the smoothie products with PPS20 yielded an overall result of more appealing and attractive consistency characteristics with respect to creaminess and mildness of taste (less intensive sour sensation) as well as an improved phase stability.

### Example 22

### Improving the Consistency of Probiotic Products

A probiotic product consisting of water, skimmed milk, glucose/fructose syrup, maltitol syrup, dextrin, flavoring agents, sweetening agents, acidifying agents and probiotics was mixed with 7.5% by weight of PPS20. The product containing PPS is thicker, creamier and produces a more full-bodied and pleasant mouthfeel.

### Example 23

### Improving the Sensory Characteristics of Coffee/Milk Mixed Beverages

There is a great variety of such mixed beverages, the variability mainly existing in terms of content and type of coffee and the additionally employed components in the composition; also see FIG. 7. In the same sense, other mixtures of milk products and flavoring components may also be realized.

Cappuccino, for instance, has a high content (about 90%) of skimmed milk and further contains coffee extract, optionally cocoa, sugar and thickeners (e.g. carrageenan). The addition of 5 to 8% by weight of PPS20 yields a rounder, more harmonic taste and produces a significantly more full-bodied and creamier mouthfeel, which distinctly improves the sensory quality of the cappuccino.

### Example 24

### Improving the Structure and Texture of Ice Cream

Basic materials for ice cream products are milk, milk fat, fruits, fruit preparations, further flavor-determining components (e.g. coffee, cocoa), sugar and additives for achieving specific effects in the final product. According to the ingredients employed, different types of ice creams are realized, for example milk-based ice cream, cream-based ice cream, fruit ice, ice cream, ice cream with reduced milk fat content, artificial ice cream (water ice). The crucial factor in the production of ice cream is the crystal structure that is formed during the freezing process and is decisively influenced, in most cases negatively, by storage temperature, and in particular by variations thereof, during freezing storage. This leads to the formation of a grainy or gravelly structure which is irreversible and has a negative influence on consistency and mouthfeel. This impression may be significantly reduced or even eliminated by the addition of PPS, for example PPS20, already at a content of a few percent. Besides this rather general finding, there are a number of suitable possibilities for employing PPS in the ice cream sector. Particular examples are:
reduction of fat and energy content
reduction and complete substitution of additives
production of lactose-free ice/ice cream
realization of entirely novel products and compositions

### Example 25

### Drying of PPS

Also in the production of dry products, convenience plays an important part that begins with the use of basic materials and compounds as intermediate products for obtaining liquid or pasty final products and ends with complete products that are only soluble, for instance, in water or milk.

All drying methods are based on a more or less gently performed dehydration. Thus, various methods for drying PPS may be contemplated, from drum drying to the broadly applicable method of spray drying right down to the more elaborate process of freeze drying.

The drum drying process yields flakes of PPS that have the same chemical-physical characteristics as non-dried PPS upon rehydration.

For spray drying, PPS having a dry mass content of more than 40% should be employed. The spray drying process yields beads of PPS that do not meet the requirements made on instant products in terms of solubility, but also exhibit all the relevant characteristics of fresh PPS upon rehydration.

The freeze-drying process yields a dry product that meets all requirements. However, as flavor is irrelevant with PPS and freeze-drying is the most elaborate drying technique, it will be attempted to achieve instant characteristics via another approach.

### Example 26

### Production of Dry PPS and of Dry Products Containing PPS Having Instant Characteristics

Instant characteristics require a reconstitution capacity that facilitates re-dissolving without the need for substantial mechanical support. One method that can readily be combined with drying methods is agglomeration, wherein particle clusters are formed from individual dry particles, for example from beads, in which physical forces effect a rapid hydration and thus a solubilization of the dry mass, for example without stirring. In this manner, for instance spray drying with subsequent agglomeration may confer instant characteristics, which is desirable for the consumer in case of liquids.

One possible example is the preparation of a dried and PPS-based mixed milk beverage in order to confer the sensory advantages of the use of PPS to such a product as well. In this manner, a mixed milk beverage, for example a coffee/milk mixed beverage according to Example 22, may be prepared as follows:
preparation of a coffee/milk combination
pre-concentration to a specific dry mass content (depending on the viscosity of the product)
spray drying
agglomeration step
and thus realization of instant characteristics
packaging in oxygen-deprived atmosphere
addition of water and solubilization of the product, which then corresponds to a freshly produced or prepared product.

Methods for the production of instant preparations are known to the person skilled in the art and have been described in the literature; see for example the German utility model document DE 20 2007 012 897 U1, the disclosure content of which is hereby incorporated by reference in the present description.

The above-mentioned Examples are also carried out using other PPS variants, for example with vegetable protein, preferably according to the use thereof as indicated in FIGS. 4 to 7 with respect to different foods and food classes, and yield similarly positive results.

### Example 27

### Preparation of a Creamy Emulsion Using Carvacrol

PPS20-PE, produced employing oregano herb oil concentrate, is readily spread on the skin and does not leave an oily film. The emulsion having an antibiotic effect is rapidly absorbed by the skin and is well suited for compressions. It can also easily be diluted in hot or cold beverages and exhibits no oil separation.

### Example 28

### Preparation of a Skin Cream

PPS34-PE having an oil content of 30% consists of 15% of natural argan oil, 15% of chamomile herb oil concentrate and 2.5% of dexpanthenol. The viscous cream is easily spread and rapidly absorbed.

### Example 29

### Improving a Skin Cream

10% of PPS20-CM are mixed into a commercially available hand care cream containing 15% of chamomile herb oil concentrate. The resulting cream has a smoother consistency and is more rapidly absorbed by the skin.

### Example 30

### Eco-Friendly Adhesive

PPS20-PE containing 2 and 4% of PE, respectively, is readily spread on fiber board, metal, glass, PET material or fabric and is rapidly absorbed by cardboard, paper, porous wood and textile fabric. Upon drying of PPS (faster with heat input), the coated and pressurized sites are firmly bonded. Supernatant PPS forms a light-colored film. PPS adhesive can also be admixed with aromatic components in the oil phase (e.g. lavender herb oil concentrate).

PPS adhesive is excellently suited for the bonding of materials where a non-permanent bonding is desired that can be separated again easily and without any damage, for example by wetting or soaking in water or by mechanical influence. PPS is advantageous as no organic solvents are used, the raw materials employed are of natural origin, the bonding sites have a high mechanical strength but may easily be separated by wetting and the bonded materials may be re-used for other purposes without exhibiting visible bonding sites.

The ingredients of PPS adhesive are eco-friendly and the bonding characteristics, the consistency and the characteristics of adhesion on the respective material may readily be adjusted via the contents of biopolymers and dispersed oil. The use of linseed oil as dispersed phase facilitates the subsequent increase in bonding stability by means of gumming.

### Example 31

### Decoration Paint and Paint Medium

PPS20-PE containing 4% of HE pectin is enriched with 1% Brilliant Blue powder (E133). The resulting PPS has an intense blue color and may be universally employed as decoration paint due to its excellent adhesion on hydrophilic and hydrophobic surfaces (wood, cardboard, metal, synthetic materials). The paint may readily be removed using aqueous solutions.

If PPS having an increased dye powder content is dried on strips (cardboard, synthetic materials) or sticks (wood, synthetic materials, metal), these may be employed for a quick preparation of dye solutions by inserting them into an aqueous solution (e.g. for dying Easter eggs or fabrics colors). The dried PPS dye solution is very resistant against mechanical influences and does not stain in a dry state.

The above-mentioned Examples are also carried out using other PPS variants, for example with vegetable protein, and yield similarly positive results.

1-54. (canceled)

55. A method for producing a phase-stable oil-in-water (O/W) fine emulsion having a dry mass content of between 5 to 60% by weight, containing, as a percent of the total weight of the emulsion, the following components:
(i) 0.2 to 10.0% by weight of a protein component;
(ii) 0.3 to 10.0% by weight of a polar polysaccharide component;
(iii) 0.1 to 60.0% by weight of a fat/oil component; alone or in addition to
(iv) 0 to 30.0% by weight of a polyol component;
which comprises: (a) preparing a phase that comprises of the fat/oil component (oil phase) alone or mixed with all or a portion of the polysaccharide component; (b) dispersing the phase prepared in (a) in an aqueous phase that comprises the protein component and any of the polysaccharide component not already present to obtain an emulsion, and (c) treat said emulsion from (b) to obtain the fine emulsion.

56. The method according to claim 55, wherein in step (a) the phase comprises the fat/oil component (oil phase) and in step (b) is dispersed in an aqueous phase that comprises the protein in step (b) and the polysaccharide component; or the oil phase is mixed with the polysaccharide component and is dispersed in an aqueous phase containing the protein component.

57. The method according to claim 55, wherein the protein component comprises a whey protein isolate, a milk protein concentrate, a sodium caseinate, a skimmed milk powder, or a plant protein.

58. The method according to claim 57, wherein the protein component is a plant protein selected from the group consisting of a pea protein, a soy protein, a lupine protein or a potato protein.

59. The method according to claim 55, wherein the polysaccharide component comprises a sodium carboxymethylcellulose (CMC) or a pectin.

60. The method according to claim 59, wherein the pectin comprises high-esterified or amidated low-esterified pectin.

61. The method according to claim 55, wherein the ratio of the % by weight of protein to % by weight polysaccharide in the fine emulsion is in a range between 4 to 1 and 1 to 4.

62. The method according to claim 55, wherein the fat/oil component is selected from the group consisting of a plant oil, an essential oil, a liquid plant fat, an animal fat, a mineral oil and a MCT oil.

63. The method according to claim 55, wherein the fine emulsion comprises components (i) to (iii).

64. The method according to claim 55, wherein the fine emulsion comprises 0.75 to 5.0% by weight of protein component, 0.5 to 2.5% by weight of polysaccharide component and 5.0 to 50.0% by weight of the fat/oil component.

65. The method according to claim 64, wherein the composition of the fine emulsion is one of the following compositions:

| | PPS type | | | |
|---|---|---|---|---|
| Composition (% by weight) | 7 | 20 | 34 | 51 |
| Protein | 1 | 2 | 2 | 3 |
| Polysaccharide PE (sodium | 1 | 3 | 2 | 3 (2) |
| CMC) | | | | |
| Fat/oil components | 5 | 15 | 30 | 45 |
| Water | 93 | 80 | 66 | 49 |

66. The method according to claim 55, wherein in the fine emulsion the particle size of the dispersed oil or fat drops in maximum dispersion is x_{50.3}≦10 μm (volume-related median value).

67. A method of preparing a dried, solid composition which comprises preparing a fine emulsion according to the method of claim 55 and then concentrating and/or drying the fine emulsion to prepare the dried, solid composition.

68. A fine emulsion obtainable by the method according to claim 55.

69. A fine emulsion according to claim 68, wherein said emulsion is a flowable, thick, viscous, tight-creamy liquid, creamy-pasty or tight-creamy pasty mass.

70. A dried, solid composition obtainable by the method of claim 67.

71. A method for producing a food product that is altered with respect to its sensory, functional and/or nutritional physiological characteristics, comprising:
(a) providing an oil-in-water (0/W) emulsion containing the following components, as a percent of the total weight of the emulsion:
(i) 0.2 to 10.0% by weight of protein component;
(ii) 0.3 to 10.0% by weight of polar polysaccharide component;
(iii) 0.1 to 60.0% by weight of a fat/oil component;
(iv) 0 to 30.0% by weight of a flavoring oil component;
(v) 0 to 30.0% by weight of a polyol component;
(vi) 0 to 1.0% by weight of a flavoring agent;
(vii) 0 to 1.0% by weight of an acid;
wherein the particle size of the dispersed oil or fat drops in maximum distribution is x_{50.3}≦10 μm (volume-related median value); and wherein the dry mass content of the emulsion is between 5 and 60% by weight; and
(b) mixing the emulsion provided in step (a) with a basic food material to produce the food product, wherein the emulsion is present at 0.1 to 75% by weight, of the total weight of the basic food material present in the food product.

72. A method for producing a food product that is altered with respect to its sensory, functional and/or nutritional physiological characteristics, comprising:
(a) providing an oil-in-water (O/W) emulsion containing the following components, as a percent of the total weight of the emulsion:
(i) 0.2 to 10.0% by weight of protein component;
(ii) 0.3 to 10.0% by weight of polar polysaccharide component;
(iii) 0.1 to 60.0% by weight of a fat/oil component;
(iv) 0 to 30.0% by weight of a flavoring oil component;
(v) 0 to 30.0% by weight of a polyol component;
(vi) 0 to 1.0% by weight of a flavoring agent;
(vii) 0 to 1.0% by weight of an acid;
wherein the particle size of the dispersed oil or fat drops in maximum distribution is x_{50.3}≦10 μm (volume-related median value); and wherein the dry mass content of the emulsion is between 5 and 60% by weight; and
(b) mixing the emulsion provided in step (a) with a basic food material to produce the food product, wherein the emulsion is present at 0.1 to 75% by weight, of the total weight of the basic food material present in the food product,
wherein the emulsion provided is prepared according to the method according to claim 55.

73. The method according to claim 71, wherein the food product is a milk product or a milk replacement product.

74. The method according to claim 71, wherein the food product is not a beverage.

75. The method according to claim 71, further comprising a step of concentrating and/or drying to produce the food.

76. A food product obtainable by a method according to claim 71.

77. A food product according to claim 76, selected from the group consisting of a milk or dairy product, a smoothie, a confectionery, a specialty food product, a soup, a sauce, a marinade, an infant formula, an ice cream product, a meat product, a dough, a baked good, a dietetic food, a food additive or a power food.
